(19) United States
(12) Patent Application Publication
(10) Pub. No.: US 2002/0081020 A1
(43) Pub. Date: Jun. 27, 2002

(54) Infromation providing server, client, information providing system processing method, recording medium recording a program, and advertisement providing method

(75) Inventor: Hideo Shimazu, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/023,886

(22) Filed: Dec. 21, 2001

(30) Foreign Application Priority Data
Dec. 25, 2000 (JP) 2000-393628

(51) Int. Cl. G06K 9/00

(52) U.S. Cl. 382/154

(57) ABSTRACT

The present invention has a three-dimensional image data conversion part 101 for converting aerial photographs A and B of the same area photographed from two different locations to three-dimensional image data, an advertisement placing information storage part 105 for storing advertisement placing information added to the three-dimensional image data, a clock part 104 for managing the current date, a three-dimensional image synthesizing part 102 for referring to the advertisement placing information storage part 105 to fetch advertisement placing information in which a placing period includes the current date and adding the advertisement contents included in the fetched advertisement placing information to the three-dimensional image data to generate and output synthesis three-dimensional image data, and a three-dimensional image browser 103 for receiving the synthesis three-dimensional image data to present a three-dimensional image stereoscopic representation based on viewpoint position information from a user and further upon reception of another viewpoint position, regenerating and presenting a three-dimensional image stereoscopic representation from the new viewpoint position.

### BACKGROUND OF THE INVENTION

The present invention relates to an information providing server, a client, an information providing system processing method, a recording medium recording a program, and an advertisement providing method. In particular, the present invention relates to an information providing server, a client, an information providing system processing method, a recording medium recording a program, and an advertisement providing method which provide a three-dimensional stereoscopic image of a location desired by a user and advertisement information in the three-dimensional stereoscopic image.

The following two methods for searching for a Web page of WWW and a page of i mode have been known. One method is that a searcher sequentially selects a previously created menu to follow the link to a desired page. The other method is that a searcher gives a keyword to a search engine to search for a page which is hit onto the same. (A first prior art)

In these search methods, however, a page is searched independently entirely of a physical position. For example, when a searcher searches for information on a flower shop, an information providing server based on these search methods provides a page hit irrespective of a position in which the searcher himself/herself actually exists, such as flower shops in Tokyo, Paris and Sapporo. Such prior art search methods are convenient when searching for information irrespective of location information. However, the prior art search methods are inconvenient when the searcher searches for information related to location information. For example, when the searcher is now standing in front of Shibuya Station and desires to search for information on a suitable flower shop, it is sufficient that the searcher acquires information on only the pages of flower shops around Shibuya Station. Also in this case, when the searcher performs searching by the prior art search methods, even pages of flower shops in Paris and Sapporo are provided to the searcher.

As a system for solving such inconvenience, the following system has been already proposed. The system first provides a searcher with two-dimensional map information. The searcher then commands a certain position on the map. The system follows the link to shop information in the location to provide information on the shop. Such a thing exists very typically. For example, the system displays the map of a certain country, and when the searcher specifies a certain prefecture in the displayed map, the system follows the link destination to information on the prefecture. (A second prior art)

For example, the home page of French Government Tourist Office (http://www.franceinformation.or.jp/oindex/index.html) corresponds to this. On this home page, when the system displays a French map and the searcher clicks on a certain prefecture in the displayed map with a mouse, the system follows the link to information on the prefecture to display information on the prefecture linked. Such a technique can be easily realized on the Web page using a clickable map technique. For this reason, such a technique is used very frequently on a Web page.

As an invention for providing advertisement information on a Web page using such a technique, there is Japanese Patent No. 2756483 “Method for providing advertisement information and method for registering the same”. The Patent No. 2756483 “Method for providing advertisement information and method for registering the same” limits information on the link destination the system follows upon click of a searcher to advertisement information and a map the system displays to the searcher to a two-dimensional map. (A third prior art)

The second and third prior arts have the following problems.

In the second and third prior arts, a system manager is hard to update map information. In particular, since rebuilding of a building and construction of a new road are frequent in a big city, manual maintenance and update for quickly reflecting the latest information on to the map are very hard work. In addition, in the second and third prior arts, the system manager must manually erase an advertisement placed on the two-dimensional map information (such as a banner advertisement) in accordance with expiration of a placing period commanded from and contracted with a sponsor. Similarly in the case of placing a new advertisement on the two-dimensional map information, in the second and third prior arts, the system manager must manually execute a placing process. (A first problem)

Further, in the second and third prior arts, the searcher is bored with the search operation. In other words, information search from a plane map expressed in two dimensions is convenient in view of a search operation, but is boring when viewed from the user side. Such searching information from a two-dimensional map is an operation as if a station in a line is searched in a timetable and boring. (A second problem)

Furthermore, the methods using the second and third prior arts have few successful examples in business. In a method in which an information providing server using the second and third prior arts provides an information service, the system manager typically collects a fee from a user. However, when using such a fee collecting system, it is difficult to be successful in business.

In the prior art fee collecting system, the system manager uses the Internet to prepare a database in a server and uses various media to advertise that there is a home page for providing a service to a specific URL. The system manager prepares in the system a use fee collecting system on a home page of a specific URL. When a client terminal specifies the URL, the system collects a fee from the client terminal on the specified home page. As a method for realizing this, there are a typically known method for inputting a credit card number on a sales site using the Internet, and a method for using a prepaid card which is electronic cash for the purpose of payment on the Internet.

After the system collects the use fee on the home page, the system sends to the client terminal a program for using a service desired by the user. The user can execute the sent program using the client terminal so as to use the service. However, there are few successful examples in the Internet business using such a method for collecting a use fee from the user. (A third problem)

### SUMMARY OF THE INVENTION

An object of the present invention is to provide an information providing server, a client, an information providing system processing method, a recording medium recording a program, and an advertisement providing method. The present invention has been made in view of the foregoing problems, and can reduce operating burden required for maintenance and update of map information or advertisement information. Further, the present invention can give a searcher a visual effect in which a user can enjoy a search operation. A system for placing advertisement information from a sponsor is structured so that a system manager can provide a user for free with a service for sightseeing in a three-dimensional image space (a three-dimensional aerial sightseeing service).

### BRIEF DESCRIPTION OF THE DRAWINGS

FIG. 1 is a block diagram showing the configuration of a system using the present invention;

FIG. 2 is a block diagram showing the schematic configuration of an information providing server according to a first embodiment of the present invention;

FIG. 3 is a diagram of assistance in explaining a detail of each process of a three-dimensional image data conversion part according to the first embodiment of the present invention;

FIG. 4 is a diagram showing a specific example of a DEM image as intermediate representation;

FIG. 5 is a diagram showing a specific example of a three-dimensional image stereoscopic representation;

FIG. 6 is a plan view showing a display example of a three-dimensional aerial sightseeing service screen which places advertisement information;

FIG. 7 is a block diagram showing the schematic configuration of an information providing server according to a second embodiment of the present invention;

FIG. 8 is a concept view showing an advertisement providing method according to an embodiment of the present invention;

FIG. 9 is a sequence chart showing a processing example of the information providing server according to the second embodiment of the present invention;

FIG. 10 is a block diagram showing the schematic configuration of an information providing server according to a third embodiment of the present invention;

FIG. 11 is a plan view showing a first display example of a client terminal provided with a position output type three-dimensional image browser;

FIG. 12(a) to (d) are a plan view showing a second display example of the client terminal provided with a position output type three-dimensional image browser;

FIG. 13 is a sequence chart showing a processing example of the information providing server according to the third embodiment of the present invention;

FIG. 14 is a block diagram showing the schematic configuration of an information providing server according to a fourth embodiment of the present invention;

FIG. 15 is a flowchart showing a processing example of a three-dimensional image browser according to the fourth embodiment of the present invention;

FIG. 16 is a concept view showing a state to request related information presentation by specifying a specific landmark during sightseeing in a three-dimensional image stereoscopic representation;

FIG. 17 is a block diagram showing the schematic configuration of an information providing server according to a fifth embodiment of the present invention;

FIG. 18 is a block diagram showing the schematic configuration of an information providing server according to a sixth embodiment of the present invention; and

FIG. 19 is a block diagram showing the schematic configuration of a data processor and a recording medium according to an embodiment of the present invention.

### DETAILED DESCRIPTION OF THE PREFERRED EMBODIMENTS

Embodiments of the present invention will be described with reference to the accompanying drawings.

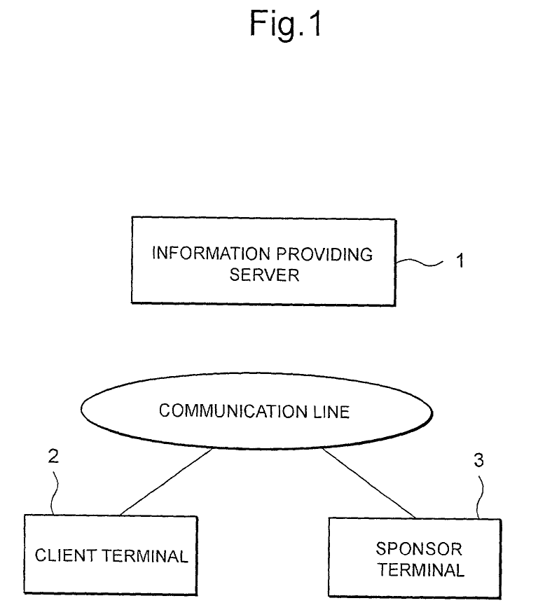

FIG. 1 shows an overview of a system using an information providing server and a client terminal according to an embodiment of the present invention. As shown in FIG. 1, the system of the present invention has an information providing server 1, a client terminal 2, and a sponsor terminal 3 which are connected to each other via a communication line 100 (e.g., the Internet).

The information providing server 1 delivers to the client terminal a three-dimensional image stereoscopic representation generated based on three-dimensional image data based on a viewpoint position inputted from the client terminal 2 and advertisement information provided by the sponsor terminal 3, thereby providing a user with a three-dimensional aerial sightseeing service.

A user inputs a desired viewpoint position on the client terminal 2. The client terminal 2 receives via the communication line 100 and displays the three-dimensional image stereoscopic representation generated based on ‘the three-dimensional image data corresponding to the viewpoint position sent from the information providing server 1’ and ‘the advertisement information’.

The sponsor terminal 3 sends to the information providing server 1 an advertisement placing request (the time (placing period) and the location (placed position) to place a desired advertisement (the advertisement contents). The information providing server 1 generates a three-dimensional image stereoscopic representation based on the advertisement information the sponsor terminal 3 requests to place and the three-dimensional image data. The information providing server 1 delivers the generated three-dimensional image stereoscopic representation to the client terminal 2.

<The Configuration of an Information Providing Server of a First Embodiment>

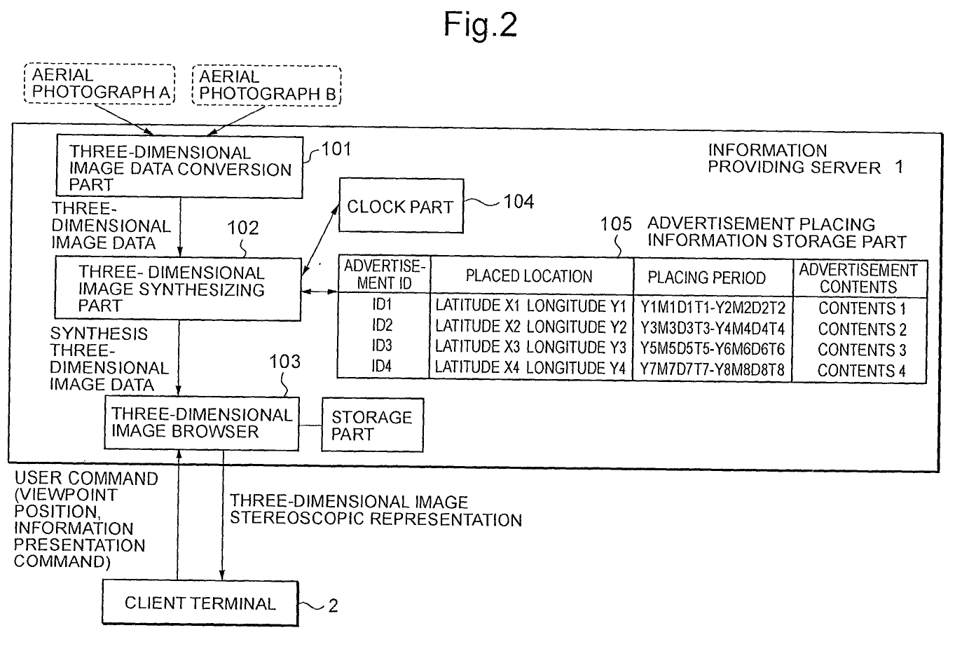

FIG. 2 shows the configuration of an information providing server according to a first embodiment of the present invention. An information providing server 1 according to the first embodiment of the present invention has a three-dimensional image data conversion part 101, a three-dimensional image synthesizing part 102, a three-dimensional image browser 103, a clock part 104, and an advertisement placing information storage part 105.

The three-dimensional image conversion 0part 101 converts two-dimensional image information to three-dimensional image data. At least two aerial photographs (aerial photographs A and B) of the same area photographed from different locations are inputted to the three-dimensional image data conversion part 101. The physical position of the photographed area (the physical position of a reference point included in the photographs) is specified in the two aerial photographs. The three-dimensional image data conversion part 101 uses the inputted two aerial photographs to perform a stereo process, a DEM process and a polygon process, and generates three-dimensional image data which is then outputted to the three-dimensional image synthesizing part 102.

In the following explanation, photographs of the same area (the earth's surface) photographed periodically like a satellite image of a space satellite or an aerial photograph of an airplane are referred to as an aerial photograph. The aerial photographs A and B must not be always photographed in the right and left directions. The aerial photographs A and B of the same area photographed at different angles may be photographed in the up and down directions.

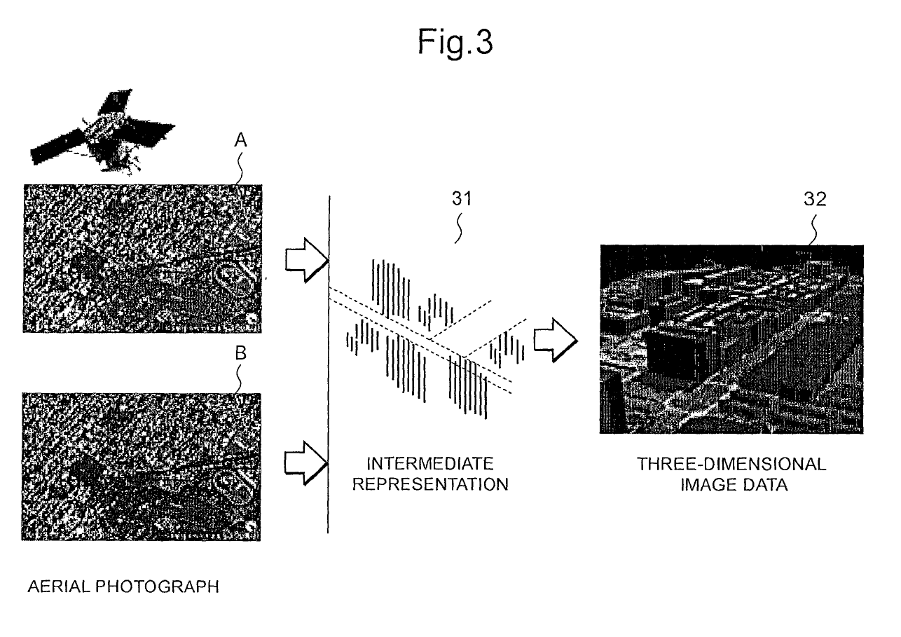

FIG. 3 is a diagram of assistance in explaining the process of the three-dimensional image data conversion part 101. The three-dimensional image data conversion part 101 uses a parallax between at least two aerial photographs of the same location photographed (the aerial photographs A and B) to calculate a value in the height direction of a building or a mountain (the stereo process). The three-dimensional image data conversion part 101 then allows the calculated height direction value to be elevation meshed (DEM imaging: Digital Elevation Model) to reproduce an intermediate representation 31 (DEM image).Further, the three-dimensional image data conversion part 101 performs a polygon process to the reproduced intermediate representation 31 (DEM image) to automatically generate three-dimensional image data 32. The information providing server 1 gradually changes the three-dimensional image data 32 generated based on the viewpoint position from the user so as to provide the user with a three-dimensional aerial sightseeing service as if the user is sightseeing in the air.

The above-mentioned photograph is generally sold by an aerial photograph provider. For example, an aerial photograph for one kilometer around photographed by the artificial satellite IKONOS operated by Space Imaging in the United States is sold for several thousand yen (in the case of a monochrome photograph) by the subsidiary thereof in Japan. Since the IKONOS takes a photograph of the entire earth for a fixed period, the system manager can purchase a latest aerial photograph of the surface of the entire earth every week. Such an aerial photograph is provided with exact latitude and longitude information. The purchaser can exactly grasp the physical position information to show what area is photographed.

In the stereo process using an aerial photograph, information on which is a building or which is a mountain is not extracted. In the stereo process using an aerial photograph, height information for each unit location is only calculated. For example, in the stereo process using an aerial photograph taken by an airplane which can fly low, a height of the earth's surface for 25 cm around can be calculated. The artificial satellite IKONOS takes a photograph high up in the sky. In the stereo process using an aerial photograph of the artificial satellite IKONOS, a height of the earth's surface for 1 m around can be calculated. As shown in FIG. 3, the result of the stereo process (height information for each unit location) becomes the intermediate representation 31 (DEM image) like a needle point holder used for flower arrangement.

The stereo process is an already-established technique. The present invention may use the existing suitable stereo process. In the present invention, the stereo process is not limited to a specific stereo process.

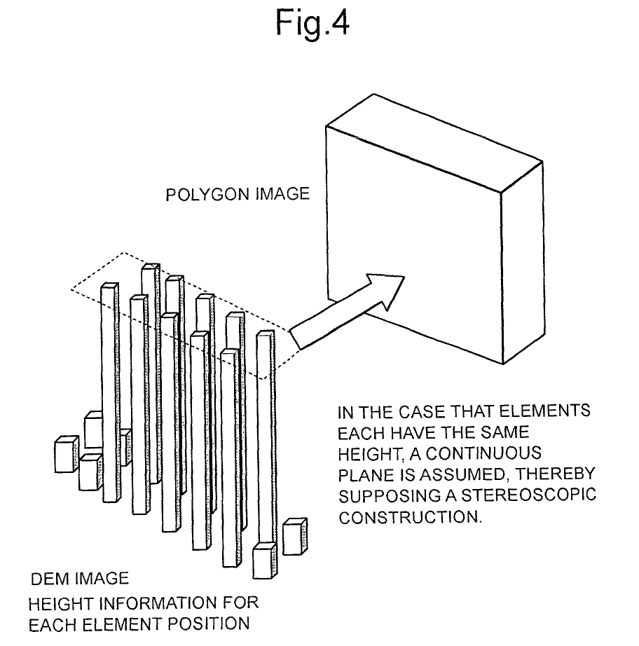

FIG. 4 is a diagram showing a specific example of the intermediate representation 31 (DEM image). The DEM image extracts height information for each element position. As shown in FIG. 4, the height information for each element position is shown by a rectangular parallelepiped shape. The case of calculating height information for 1 m around will be described. When a building having a height of 30 m is located in the range for 20 m around, height information of a height of 30 m is extracted on 400 (20×20) points in the range in which the building is located. When the periphery of the building is a level ground, height information of a height of 0 m is extracted on a point other than the 400 points. When a rule that “in the case that points of the same height are continuous, this means one building” is applied here, it can be assumed that there is a building in the range of the 400 points. In the case that elements each have the same height information in this way, a continuous plane is assumed, thereby supposing a stereoscopic construction. The polygon process is performed to the DEM image. As a result, polygon data can be obtained.

When the stereo process and the polygon process are performed, the so-called landmark such as a building or mountain is extracted as polygon data. In the present invention, the data >includes one or more landmarks of the extracted polygon data is referred to as three-dimensional image data. An aerial photograph is provided with exact positional information of the reference point in the photograph. The positional information of the landmark included in the three-dimensional image data (the positional information on the earth's surface such as a latitude or longitude) can be easily calculated by a distance from the reference point.

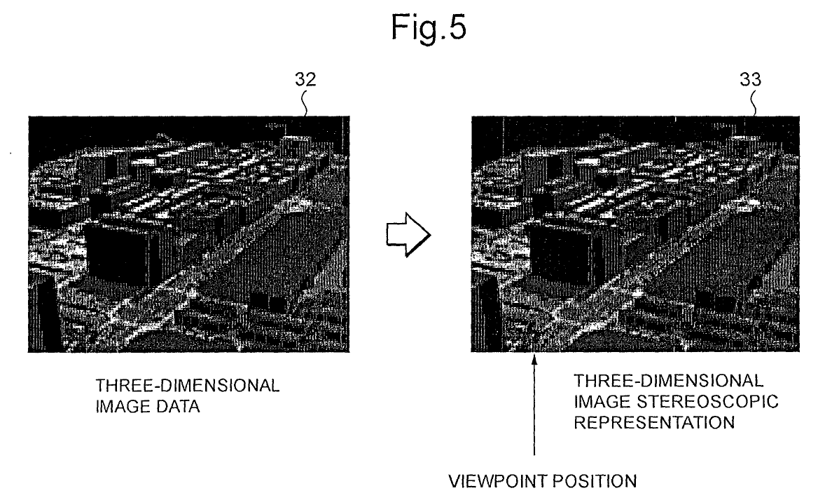

FIG. 5 shows a specific example of the three-dimensional image stereoscopic representation. The information providing server 1 uses the three-dimensional image data 32 generated by the above-mentioned stereo process, DEM process and polygon process, and creates a three-dimensional image stereoscopic representation 33 shown in FIG. 5 which is then delivered to the client terminal 2. To generate the three-dimensional image stereoscopic representation 33, the information providing server 1 needs a viewpoint position to indicate from what viewpoint it is viewed. The information providing server 1 uses the viewpoint position to generate the three-dimensional image stereoscopic representation 33 viewed from different positions.

The information providing server 1 uses the viewpoint position which is gradually, continuously moved so as to generate the three-dimensional image stereoscopic representation which is then provided to the user. The information providing server 1 can thus provide the user with a service as if the user is performing a sightseeing flight in the air.

The three-dimensional image synthesizing part 102 uses the three-dimensional image data converted by the three-dimensional image data conversion part 101 and advertisement placing information stored in the advertisement placing information storage part 105 to generate synthesis three-dimensional image data. The three-dimensional image synthesizing part 102 refers to the clock part 104 to acquire the current date data, fetches the advertisement placing information (including information of an advertisement ID, a location, a placing period, and the advertisement contents) stored in the advertisement placing information storage part 105, and judges whether the “placing period” item included in each of the advertisement placing information includes the acquired current date data or not. The three-dimensional image synthesizing part 102 judges whether the “location” item included in each of the advertisement placing information is a location included in the three-dimensional image data or not. The three-dimensional image synthesizing part 102 extracts the advertisement placing information in which the “placing period” includes the current date data and the “location” is a location included in the three-dimensional image data, and fetches data registered in “the advertisement contents” item included in the extracted advertisement placing information. The three-dimensional image synthesizing part 102 uses the fetched advertisement contents data and the three-dimensional image data outputted from the three-dimensional image data conversion part 101 to generate synthesis three-dimensional image data and outputs the generated three-dimensional image data to the three-dimensional image browser 103. The positional information of the three-dimensional image data can be calculated from the position of the aerial photograph. The three-dimensional image data outputted from the three-dimensional image data conversion part 101 is represented by a set of polygon data such as a cylinder or parallelepiped. In order to represent an advertising balloon shaped advertisement item as a new advertisement medium, the three-dimensional image synthesizing part 102 may only add advertising balloon-shaped polygon data to the three-dimensional image data.

The three-dimensional imagebrowserlo3 uses the synthesis three-dimensional image data outputted from the three-dimensional image synthesizing part 102 to generate a three-dimensional image stereoscopic representation. When the three-dimensional image browser 103 receives the synthesis three-dimensional image data outputted from the three-dimensional image synthesizing part 102, it stores once the synthesis three-dimensional image data into the storage part. The three-dimensional image browser 103 waits for a command from the client terminal 102. When a specific viewpoint position is inputted from the client terminal, the three-dimensional image browser 103 creates a three-dimensional image stereoscopic representation viewed from the inputted viewpoint position which is then provided to the user. The three-dimensional image browser 103 waits again for a command input of the viewpoint position from the client terminal 2. In the drawing, the information providing server 101 has the three-dimensional image browser 103, but the client terminal 2 may have the three-dimensional image browser 103.

The clock part 104 manages and holds the current date data. The clock part 104 outputs the current date data to the three-dimensional image synthesizing part 102 based on an acquisition request of the current date data from the three-dimensional image synthesizing part 102.

The advertisement placing information storage part 105 stores advertisement placing information including the advertisement contents an advertisement provider desires to place in order to place a specific advertisement in the three-dimensional image data converted by the three-dimensional image data conversion part 101. The advertisement placing information stored in the advertisement placing information storage part 105 includes an advertisement ID, a placed location to place an advertisement, a placing period, and the advertisement contents to be placed. Here, the advertisement ID is an identifier for specifying the advertisement placing information. As one form of registering the advertisement placing information, the advertisement ID, placed location, placing period, and advertisement contents are represented in an internal representation bit string and can be registered in a record unit including those. The advertisement placing information storage part 105 registers all the advertisement placing information to be placed in the three-dimensional image data.

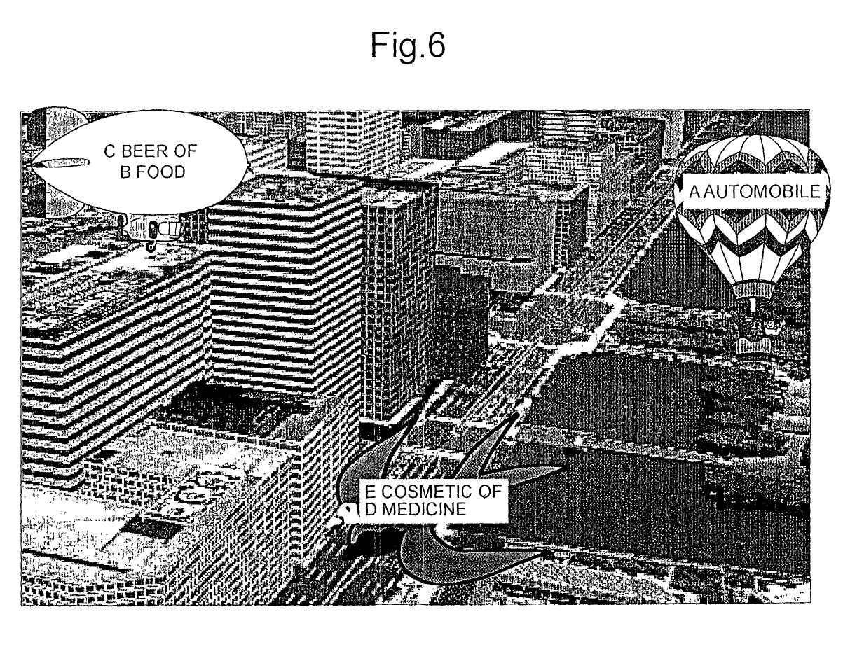

The advertisement contents included in the advertisement placing information includes shape information showing the shape of an advertisement medium and text information such as a message specified to be placed in the advertisement medium. Here, the shape information showing the shape of an advertisement medium includes various pattern shapes. For example, a shape like a drum, a shape of an advertising balloon, an airship and a swallow as shown in FIG. 6, a shape of animals, and a shape of an airplane or a thunderhead are included. A shape of a sandwich man holding a placard describing text information such as a message may be included. The text information includes not only a text but also an image, figure, or sign.

For example, a certain advertisement provider desires to place certain advertisement contents (to place an advertisement describing a message “Invitation to the Internet: NEC” in an advertising balloon-shaped advertisement medium) (IDID).The advertisement provider desires a placing period of one month from September, 2000 and a placed location in which an advertising balloon floats over the NEC head office. In this case, in the advertisement placing information storage part 105, ID1 is inputted to the [advertisement ID] item, the same latitude and longitude values as the latitude and longitude of the NEC head office are inputted to the [location] item, a value of “Y2000M9D1T0: 00-Y2000M9D30T23: 59” is inputted to the [placing period] item, and information of an advertising balloon-shaped three-dimensional polygon figure and the massage “Invitation to the Invent: NEC” of the text information displayed on the side of the advertising balloon are inputted to the [advertisement contents] item.

FIG. 6 shows a display example of the three-dimensional image stereoscopic representation actually provided from the information providing server 1 of the present invention to the client terminal. As shown in FIG. 6, advertisements displaying text information of “A automobile” for a balloon-shaped advertisement medium, “C beer of B food” for an airship-shaped advertisement medium, and “E cosmetic of D medicine” for a swallow-shaped advertisement medium are displayed in the three-dimensional image stereoscopic representation in a specific city. The user looks at these advertisements while the user is sightseeing in the three-dimensional image stereoscopic representation generated by the information providing server 1.

The information providing server system 1 can paste link information to a home page related to the advertisement (including a home page managed by the advertisement provider who requests to place the advertisement) onto the advertisement displayed in the three-dimensional image stereoscopic representation provided to the client terminal 2. When the user finds an interesting advertisement of the advertisements displayed during the three-dimensional aerial sightseeing, the user moves the mouse onto the advertisement and clicks on it so as to access the home page linked. The user can naturally use online shopping provided in the accessed home page. In this case, the client terminal can place home page information jumped while the display screen of the three-dimensional image stereoscopic representation is displayed.

The client terminal 2 of the present invention displays the three-dimensional image stereoscopic representation. The user can thus browse or search information as if the user is sightseeing in a three-dimensional space. When the user is sightseeing in the three-dimensional image stereoscopic representation of a specific location in order to browse information, the advertisement of an advertisement medium of a three-dimensional shape (such as advertising balloon) is displayed in the three-dimensional image stereoscopic representation. The advertisement medium of a three-dimension shape (such as an advertising balloon) is polygon data like the three-dimension shaped object (polygon data) automatically generated from an aerial photograph of another building or a park in the three-dimensional image stereoscopic representation.

A difference between the advertisement medium of a three-dimension shape and the three-dimensional shaped object such as another building or a park will be explained here. The three-dimension shaped object is created from an aerial photograph of the earth's surface really photographed and actually exists in photographing. On the contrary, the three-dimension shaped advertisement medium is not photographed when an aerial photograph is taken, that is, is of a non-existing virtual shape.

The information providing server 1 according to the first embodiment of the present invention allows the user to browse or search for information as if the user is sightseeing in a three-dimensional space. The information providing server 1 can provide the user with a service in which the user can enjoy a search operation. The advertisement contents included in the advertisement placing information stored in the advertisement placing information storage part 105 are placed in the three-dimensional image stereoscopic representation provided by the information providing server 1, so that the user can look at the advertisement irrespective of his/her own intension. It is possible to give the advertisement provider a large merit in which his/her own advertisement can be displayed to the user.

<The Configuration of an Information Providing Server of a Second Embodiment of the Present Invention>

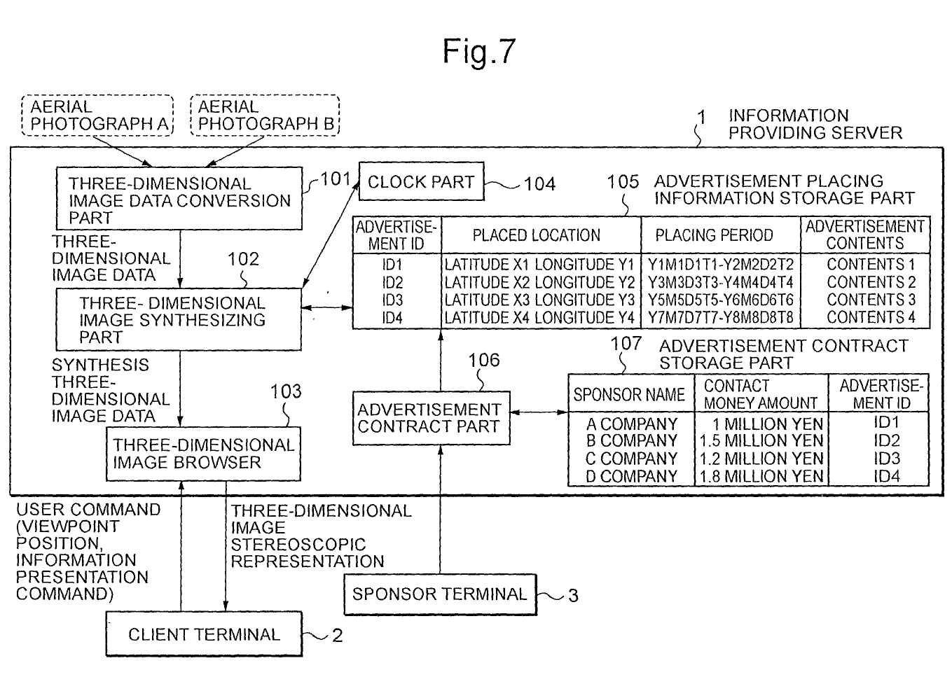

FIG. 7 shows the schematic configuration of an information providing server according to a second embodiment of the present invention. An information providing server 1 according to the second embodiment of the present invention has a three-dimensional image data conversion part 101, a three-dimensional image synthesizing part 102, a three-dimensional image browser 103, a clock part 104, an advertisement placing information storage part 105, an advertisement contract part 106, and an advertisement contract storage part 107. The same components as those of the first embodiment of the present invention are indicated by similar numerals, and the description thereof is omitted. Also in the second embodiment of the present invention, the three-dimensional image browser 103 maybe provided on the client terminal 2.

The advertisement contract part 106 executes an advertisement contract process between the advertisement contract part 106 and the sponsor terminal 3 when the sponsor terminal 3 sends an advertisement placing request. In accordance with the advertisement contract contents between the advertisement contract part 106 and the sponsor terminal 3, the advertisement contract part 106 registers or updates the contract information into the advertisement contract information storage part 107 and further registers or updates the advertisement contract information into the advertisement placing information storage part 105. The contract information includes the name of a contract sponsor, contract money amount, and an advertisement ID. The advertisement contract information is the same as that described in the first embodiment. The advertisement ID is an identifier for identifying advertisement placing information and also information showing a relation between contract information and advertisement contract information. As one form for registering the contract information into the advertisement contract storage part 107, the contract sponsor name, contract money amount, and advertisement ID are represented in an internal representation bit string and can be registered in a record unit including those.

The advertisement contract storage part 107 stores the contract information registered or updated in accordance with the advertisement contract contents between the advertisement contract part 106 and the sponsor terminal 3.

The information providing server 1 prepares various advertisement types according to the contract money amount. When the contract money amount is high, the information providing server 1 increases the display size of the advertisement contents or presents the advertisement contents in a preferable position with high frequency so that the exposure degree is increased and significant. On the other hand, when the contract money amount is low, the information providing server 1 decreases the display size of the advertisement contents or reduces the number of presentations of the advertisement contents so that the exposure degree is lowered as compared with the case of the high contract money amount. In addition, in the present invention, the three-dimensional image stereoscopic representation generated by targeting the real earth is used to provide the user with the sightseeing in a three-dimensional space. In order to place an advertisement in a popular spot where many people gather on the real earth, that is, in a position such as Tokyo Tower or the Eiffel Tower, it is apparent that the contract money amount is high as compared with the case of placing an advertisement in an unpopular spot where few people gather. An unpopular spot where few people gather is considered to be the middle of a desert or a city without any sightseeing spots.

Further, the present invention allows an advertisement provider to place an advertisement irrespective of his/her own shop position. The advertisement provider purchases from the information providing server 1 a right to place an advertisement in an initially unpopular position. When the position becomes popular rapidly (the fictitious land price is increased), the advertisement provider transfers to another person the purchased right to place an advertisement at a price higher than the initial price or can rent it to another person. The manager of the information providing server 1 can set a contract money amount corresponding to the fictitious land price and earn the operating cost of the information providing server 1.

The advertisement contract part 106 registers or updates into the advertisement placing information storage part 105 information where and how long the advertisement will be presented and what advertisement contents are like (the advertisement placing information) in accordance with the advertisement contract contents between the advertisement contract part 106 and the sponsor terminal 3. The contract between the advertisement contract part 106 and the sponsor terminal is automatically done via the communication line (such as the Internet) based on a predetermined program.

For example, as an example of automatically conducting an advertisement contract with the sponsor terminal 3, the following can be considered. The sponsor terminal inputs the advertisement contract to the home page of WWW managed and operated by the manager of the information providing server 1. When the sponsor terminal inputs the contract, the program of the information providing server 1 automatically receives the same.

Here, the advertisement contract storage part 107 and the advertisement placing information storage part 105 can be managed as one database. To establish it as business, however, it is desirable to differentiate the flow of payment of money such as contract money from the flow of the service such as advertisement placing information. In the embodiment, the case of managing the advertisement contract storage part 107 and the advertisement placing information storage part 105 in different databases will be explained.

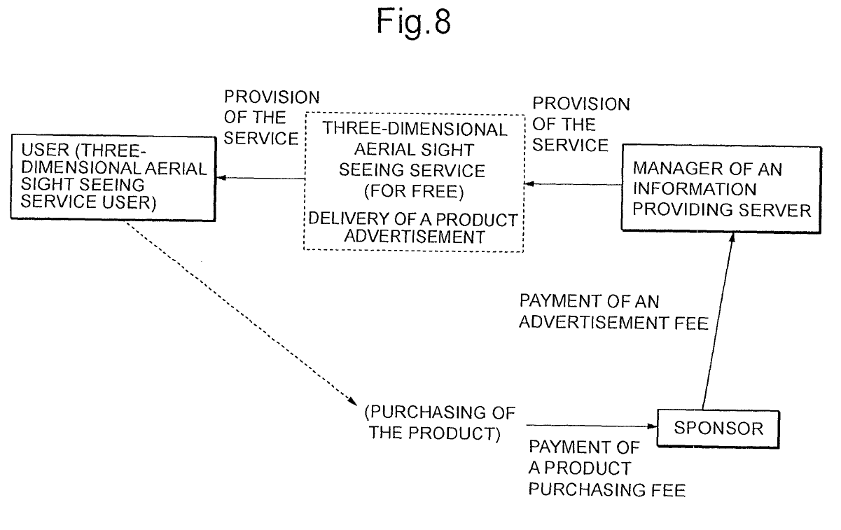

FIG. 8 is a concept view showing a business model form using the advertisement providing server 1 according to the second embodiment of the present invention. As shown in FIG. 8, a sponsor considers to place an advertisement in order to promote product sales, and uses the sponsor terminal 3 to request the manager of the information providing server 1 to place an advertisement. The sponsor pays contract money as an advertisement placing fee to the manager of the information providing server 1.

The manager of the information providing server 1 provides a user with a sightseeing service in a three-dimensional space without collecting the service use fee from the user. The reason is that the information providing server 1 provides the sightseeing service in a three-dimensional space and forcibly presents the advertisement to the user. The user looks at the advertisement provided by the sponsor for enjoyment of the sightseeing service in a three-dimensional space. The possibility that the user who looks at the advertisement may purchase a product dealt by the sponsor who has placed the advertisement becomes high. When the user looks at the advertisement in the three-dimensional image stereoscopic representation to purchase the product, the user pays the product purchasing fee to the sponsor.

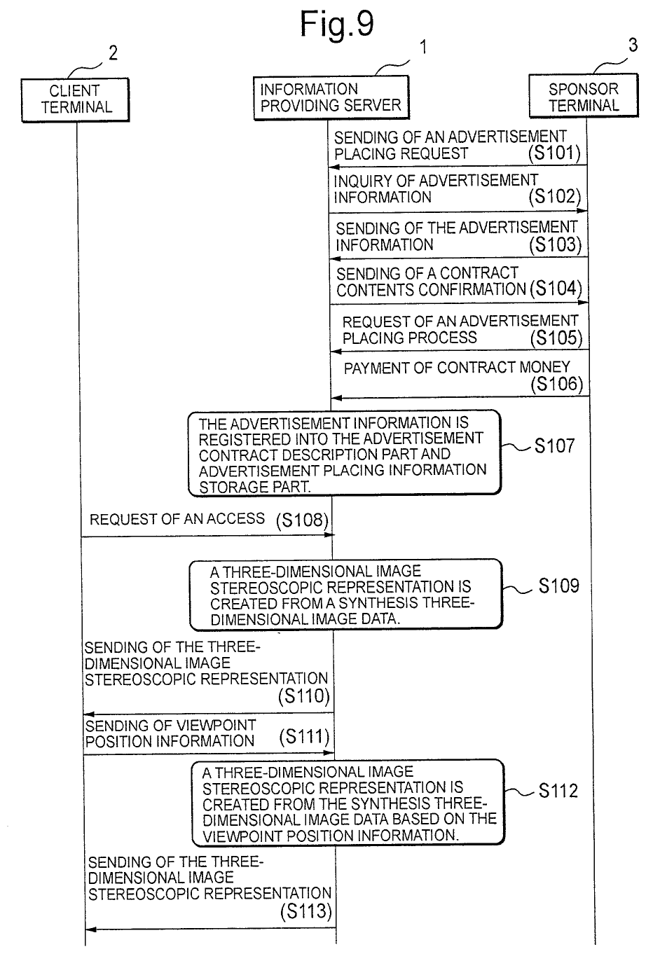

FIG. 9 shows a first processing example in the advertisement providing server 1 according to the second embodiment of the present invention. As shown in FIG. 9, the sponsor terminal 3 sends to the information providing server an advertisement placing request to place advertisement information (step S1). The information providing server 1 inquires of advertisement information including the advertisement placing information and the contract information (step S102).

To the inquiry from the information providing server 1 in step S102, the sponsor terminal 3 sends desired advertisement information (step S103).The information providing server 1 sends a confirmation of the advertisement contract including advertisement contents, a placed location, a placing period and a contract money amount and a request of the approval based on the advertisement information sent from the sponsor terminal (step S104).

In step S104, the sponsor terminal 3 which has approved the advertisement contract contents sent from the information providing server 1 requests an advertisement placing process (step S105) and pays the presented contract money to the information providing server 1 by a predetermined payment method (step S106).

The information providing server 1 which has been requested the advertisement placing process registers or updates the contract information into the advertisement contract storage part 107 in accordance with the advertisement information, and further registers or updates the advertisement placing information into the advertisement placing information storage part 105 (step S107).

The client terminal 2 requests an access to the information providing server 1 based on a command from the user (step S108). When the information providing server 1 approves the access of the client terminal 2, it uses the synthesis three-dimensional image data to generate a three-dimensional image stereoscopic representation (step S109) which is then sent to the client terminal 2 (step S110).

The client terminal 2 outputs information of a viewpoint position desired by the user to the information providing server (step Sill). The information providing server 1 generates a three-dimensional image stereoscopic representation based on the information of the viewpoint position outputted from the client terminal 2 (step S112) which is then sent to the client terminal 2 (step S113).

The information providing server 1 according to the second embodiment of the present invention can provide a browsing service or a search service to the user for free while the user is sightseeing in the sightseeing service in a three-dimensional space. The reason is that the information providing server 1 according to the second embodiment of the present invention obtains the contract money from the sponsor terminal 3 for displaying the advertisement in the three-dimensional image stereoscopic representation. Further, the manager of the information providing server 1 can manage and operate the information providing server 1 by the contract money obtained from the sponsor terminal 3. The information providing server according to the second embodiment can set a contract money amount in accordance with a fictitious land price in the advertisement placing position. The advertisement placing person having a right to place an advertisement or the manager of the information providing server 1 can set a sale price or a contract money amount corresponding to the fictitious land price for business.

<The Configuration of an Information Providing Server According to a Third Embodiment of the Present Invention>

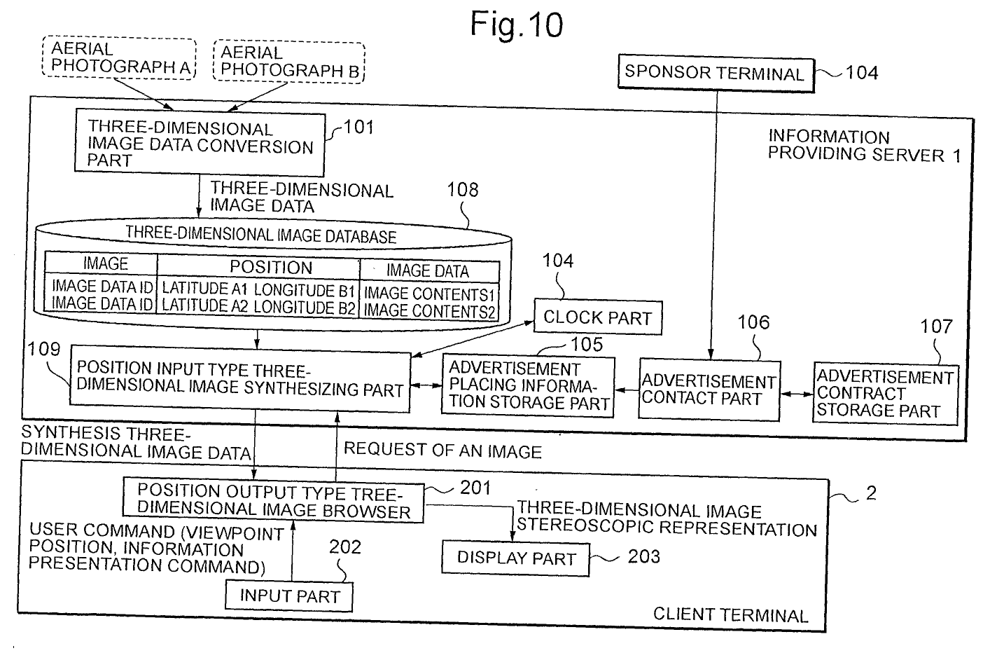

FIG. 10 shows the configuration of an information providing server 1 according to a third embodiment of the present invention. The information providing server 1 according to the third embodiment of the present invention has a three-dimensional image data conversion part 101, a three-dimension image synthesizing part 102, a clock part 104, an advertisement placing information storage part 105, an advertisement contract part 106, an advertisement contract storage part 107, a three-dimensional image database 108, and a position input type three-dimensional image synthesizing part 109. The same components as those of the first embodiment of the present invention are indicated by similar numerals. The description of the same components as those of the first embodiment of the present invention is omitted.

The three-dimensional image database 108 stores the three-dimensional image data generated by the three-dimensional image data conversion part 101. The three-dimensional image database 108 may be either a relational database or a typical file format. The three-dimensional image data includes an image ID for uniquely identifying three-dimensional image data, “position” information of three-dimensional image data (e.g., the latitude and longitude of a reference position), and image data. The image data includes one or more polygon data showing a landmark. The image ID is a number provided for uniquely identifying generated three-dimensional image data. As one form for registering the three-dimensional image data into the three-dimensional image database 108, the image ID, position and image data are represented in an internal representation bit string and can be registered in a record unit including those.

The “position” information included in three-dimensional image data will be explained. When the size of the range of the earth's surface included in three-dimensional image data generated (vertical and horizontal lengths) is fixed, it is sufficientwhenthepositionofthereferencepointoftheearth's surface included in three-dimensional image data generated based on two aerial photographs A and B (the latitude and longitude) is stored as the “position” information into the three-dimensional image data 108. Since the aerial photographs are provided with exact information of the reference point in the photographs, a position of the reference point of the earth's surface included in the three-dimensional image data can be decided using the information of the reference point in the photographs. When the size of the range of the earth's surface included in the three-dimensional image data (vertical and horizontal lengths) is different in the individual three-dimensional image data, the “position” information including the data related to the size of the range of the earth's surface (vertical and horizontal lengths) must be stored into the three-dimensional image database 108. As an example of storing the “position” information in this case, when the size of the range of the earth's surface is rectangular, it can be realized by the structure for storing two points diagonally positioned in the rectangle. A method for storing the “position” information is not limited to this, and any method may be used which can find the size of the range of the earth's surface included in the three-dimensional image data (vertical and horizontal lengths) and the position on the earth's surface.

The position input type three-dimensional image synthesizing part 109 synthesizes the three-dimensional image data based on the positional information specified from a position output type three-dimensional image browser 201 with the advertisement information. When the position output type three-dimensional image browser 201 specifies positional information, the position input type three-dimensional image synthesizing part 109 searches the three-dimensional image database 108, refers to the specified positional information and the “position” information included in the three-dimensional image data, and searches for the three-dimensional image data including the viewpoint position to fetch the corresponding three-dimensional image data. The position input type three-dimensional image synthesizing part 109 refers to the clock part 104 to acquire the current date data and refers to the acquired current date data, and the “placing period” included in the advertisement placing information stored in the advertisement placing information storage part 105 to search for the advertisement placing information in which the “placing period” includes the current date data. The position input type three-dimensional image synthesizing part 109 judges whether the “placed location” information included in the advertisement placing information is included in the size of the range of the earth's surface included in the three-dimensional image data (vertical and horizontal lengths) or not. In this manner, the position input type three-dimensional image synthesizing part 109 can search for the advertisement placing information in which the “placing period” includes the current date data and the “placed location” is included in the size of the range of the earth's surface included in the three-dimensional image data (vertical and horizontal lengths). The position input type three-dimensional image synthesizing part 109 fetches the “advertisement contents” information included in the searched advertisement placing information. The position input type three-dimensional image synthesizing part 109 synthesizes the fetched “advertisement contents” information with the three-dimensional image data fetched from the three-dimensional image database 108 to generate synthesis three-dimensional image data and delivers the generated synthesis three-dimensional image data to the client terminal 2.

The position output type three-dimensional image browser 201 included in the client terminal 2 generates a three-dimensional image stereoscopic representation based on the synthesis three-dimensional image data delivered from the position input type three-dimensional image synthesizing part 109 and the viewpoint position outputted from an input part 202.

The position output type three-dimensional image browser 201 performs an image request to the position input type three-dimensional image synthesizing part 109 based on the positional information outputted from the input part 202 and receives the synthesis three-dimensional image data from the position input type three-dimensional image synthesizing part 109. The position output type three-dimensional image browser 201 converts the received synthesis three-dimensional image data to a three-dimensional image stereoscopic representation.

When the user inputs from the input part 202 information of a specific position where the user desires to sightsee in the air, the position output type three-dimensional image browser 201 sends the positional information to the position input type three-dimensional image synthesizing part 109, and as a result, receives the synthesis three-dimensional image data. The position output type three-dimensional image browser 201 stores the received synthesis three-dimensional image data into the position output type three-dimensional image browser part 201. When the user inputs a specific viewpoint position from the input part 202, the position output type three-dimensional image browser 201 generates the received three-dimensional image data into a three-dimensional image stereoscopic representation viewed from the viewpoint position and outputs the generated three-dimensional image stereoscopic representation to a display part 203. When the user inputs a new viewpoint position, the position output type three-dimensional image browser 201 regenerates the three-dimensional image stereoscopic representation viewed from the new viewpoint position. In this embodiment, the position output type three-dimensional image browser 201 is provided on the client terminal 2, but may be provided on the information providing server 1.

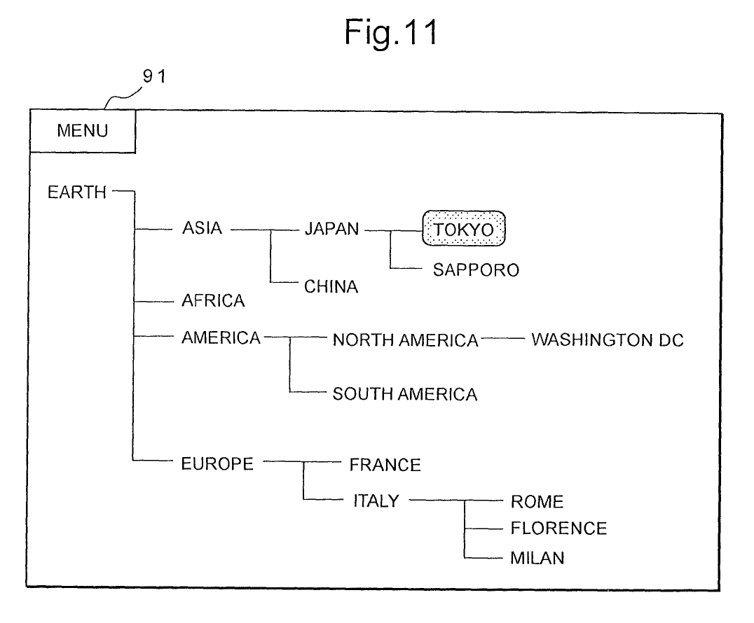

FIG. 11 shows a first display example of a screen displayed by the display part 203 of the client terminal 2. When the user requests the “menu” screen to use the three-dimensional aerial sightseeing service via the input part 202, the screen as shown in FIG. 9 is displayed on the display part 203.

The display contents of a menu 91 shown in FIG. 11 is an example for displaying the position of the entire surface of the earth by a tree structure of a hierarchy structure. It is displayed in this manner so that the user can easily input positional information. The menu 91 shown in FIG. 11 positions the entire earth in the uppermost position of a hierarchy, and the continents of Asia, Africa, America and Europe are positioned in the layer below it. In the lower layer of each of the continents, the subdivided country name of “North America” or “Japan” is positioned. In the lower layer of the country name, a city name is positioned. The display format is the same as the Explorer format (R) used in the Windows (R).

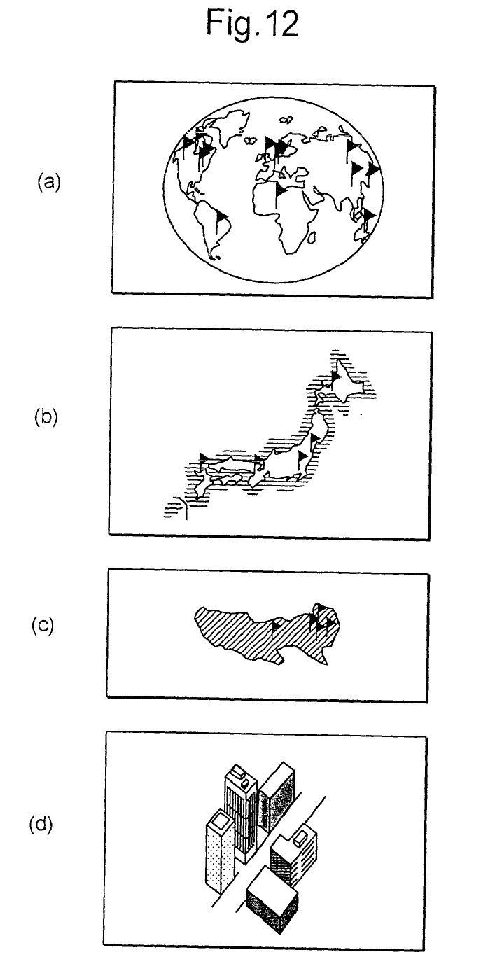

As shown in FIG. 12, the menu screen can be created by an image format. As shown in FIGS. 12(a) to 12(c), images of photographs of a globe, a Japanese map and a specific area are correspondingly pasted. The image pasted here may be either of a two-dimensional bit map format or of a snapshot in a three-dimensional space.

When the user clicks on a flag set in a given position in the earth's map shown in FIG. 12(a), the map of the countries or continents managed in the lower layer is displayed on the display part. A flag is set in a given position of each of the countries or continents, and when the user clicks on the flag, the map of each region or area is displayed on the display part. For example, when the user clicks on the flag set in Japan, the display part displays the Japanese map as shown in FIG. 12(b) in which a flag is set in each region or area. When the user clicks on the flag set on Tokyo of the flags set in the regions, the Tokyo map as shown in FIG. 12(c) in which a flag is set in each city is displayed on the display part. When the user clicks on a given flag of the flags set in the cities, a three-dimensional image stereoscopic representation of each city (Shinjuku, Harajuku, and so on) managed in the lower layer of the clicked flag is displayed on the display part, as shown in FIG. 12(d). The flag set on the map is not necessarily limited to a flag shape, and may be of other shapes.

As described above, until the user selects the menu item of the lowest level in which the user can actually use the sightseeing service in a three-dimensional space, the display part will not display a three-dimensional image stereoscopic representation. For example, when the user selects Shinjuku as a desired area, the display part of the client terminal displays the three-dimensional image stereoscopic representation of “Shinjuku”. The user can use the three-dimensional aerial sightseeing service as if the user is sightseeing over “Shinjuku”. In this case, the manager of the information providing server can paste a snapshot in a still state of the three-dimensional space image onto the lowest level menu item. The manager of the information providing server 1 can freely set the position of the lowest level that the user can actually use the aerial sightseeing service.

When the user is using the three-dimensional aerial sightseeing service and desires to enjoy an aerial sightseeing in another area or region, the following two methods can be considered.

A first method is that the three-dimensional image representations are continuously switched and continue to be displayed along with movement of the user and the user sequentially travels over a region or area. This enables the user to continuously enjoy sightseeing from over Tokyo to another region or area. For example, the user sequentially travels via the three-dimensional image displays of the regions or areas included between Tokyo and Osaka.

A second method is that the display part displays the menu screen again and the user selects the position (the area or region) where the user desires to sightsee from the menu screen. This enables the user to move instantly. For example, when the user desires to switch the image of over Tokyo to the image of over Osaka, the menu screen shown in FIG. 11 is displayed on the display part and the user moves to the hierarchy of “Japan” on the menu screen to select “Osaka” there. In this manner, the user displays the three-dimensional image representation of Osaka on the display part. Such a state is not limited to the same country. In other words, on the menu screen shown in FIG. 11, the user can instantly move to over all the countries of the world. The user can enjoy the aerial sightseeing as if the user moves instantly from over Tokyo to over Amazon or Champs Élysées in Paris. For example, when the user desires to move from Tokyo to over Champs Élysées in Paris, on the menu screen shown in FIG. 11, the user sequentially moves from the “Japan” hierarchy to the “Asia” hierarchy, the uppermost hierarchy of “the earth”, the “Europe” hierarchy, and the “France” hierarchy to select “Paris” there.

As a method in which the user specifies a specific position (location), the user can specify it based on information of the latitude and longitude. For example, when the user desires to sightsee in the three-dimensional image stereoscopic representation near Champs Élysées in Paris, the user looks up information of the latitude and longitude including the Champs Élysées area using the existing map. The user uses the input part 202 to input the information of the latitude and longitude to the position output type three-dimensional image browser 201.

As a method in which the user inputs a specific position (location), there is also the following method. For example, the information providing server 1 allows the display part of the client terminal 2 to display map information, and the user specifies a given location (a location where the user desires to sightsee in the air) with the mouse. The client terminal 2 instantly calculates information of the latitude and longitude of the specified point to send the information of the calculated latitude and longitude to the position input type three-dimensional image synthesizing part 109 of the information providing server 1. The position input type three-dimensional image synthesizing part 109 generates synthesis three-dimensional image data based on the information of the latitude and longitude which is then outputted to the client terminal 2. When the client terminal 2 receives the synthesis three-dimensional image data by the position output type three-dimensional image browser 201, it generates a three-dimensional image stereoscopic representation based on the viewpoint position from the input part 202 which is then displayed on the display part 203.

When the user inputs a desired location from the input part 202 of the client terminal 2 using the above methods, the position input type three-dimensional image synthesizing part 109 searches the three-dimensional image database 108 for the three-dimensional image data including a given location where the user desires to go. The position input type three-dimensional image synthesizing part 109 synthesizes the searched three-dimensional image data with the advertisement contents to generate synthesis three-dimensional image data. The position output type three-dimensional image browser 201 receives the generated synthesis three-dimensional image data and uses the received three-dimensional image data and the viewpoint position specified from the user to generate and display a three-dimensional image stereoscopic representation.

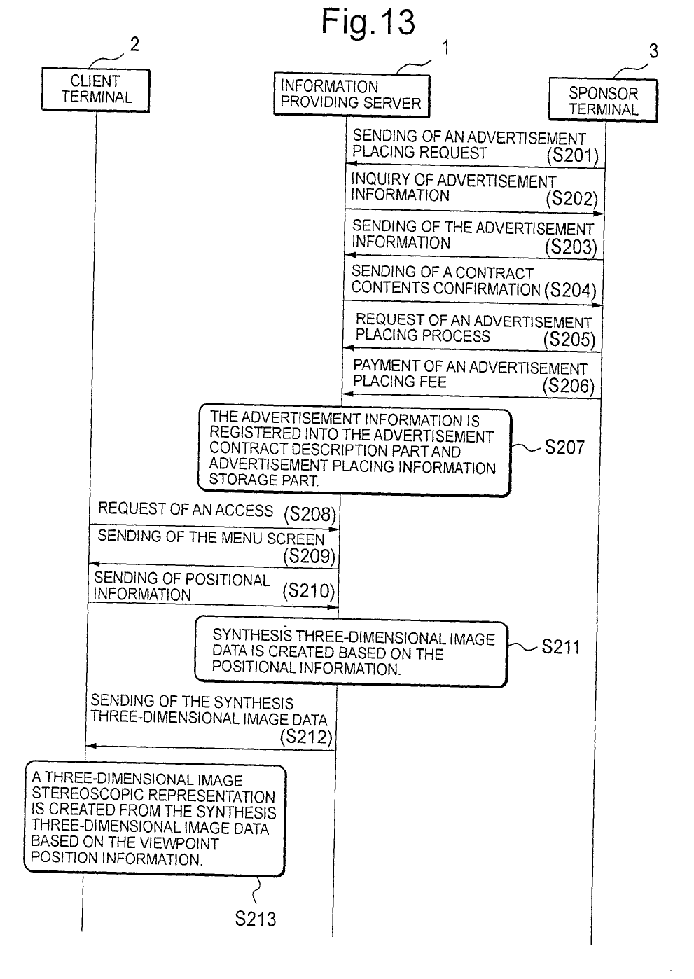

FIG. 13 shows a second processing example in the advertisement providing server 1 according to an embodiment of the present invention. The sponsor terminal 3 sends to the information providing server 1 an advertisement placing request to place an advertisement (step S201). When the information providing server 1 receives the advertisement placing request, it inquires of advertisement information including the advertisement placing information and the contract information (step S202).

To the inquiry from the information providing server 1 in step S202, the sponsor terminal 3 sends desired advertisement information (step S203). The information providing server 1 sends a confirmation of the advertisement contract including advertisement contents, a placed location, a placing period, and contract money amount and a request of the approval based on the sent advertisement information and a request of the approval (step S204).

In step S204, the sponsor terminal 3 which has approved the advertisement contract contents sent from the information providing server 1 requests an advertisement placing process (step S205) and pays the presented contracted money to the information providing server 1 by a predetermined payment method (step S206).

The information providing server 1 which has been requested the advertisement placing process registers or updates the contract information into the advertisement contract storage part 107 in accordance with the advertisement information, and further registers or updates the advertisement placing information into the advertisement placing information storage part 105 (step S207).

The client terminal 2 requests an access to the information providing server 1 based on a command from the user (step S208). When the information providing server 1 approves the access, it sends the menu screen for the three-dimensional image aerial sightseeing service to the client terminal 2 (step S209).

When the user selects a location where the user desires to sightsee in the air from the menu screen displayed on the display part 203 of the client terminal 2, the client terminal sends positional information based on the selected location to the information providing server 1 (step S210). The information providing server 1 creates synthesis three-dimensional image data based on the sent positional information (step S211) which is then sent to the client terminal (step S212).

When the user inputs a desired viewpoint position, the client terminal 2 uses the inputted viewpoint position and the sent synthesis three-dimensional image data to generate and display a three-dimensional image stereoscopic representation (step S213).

The information providing server 1 according to the third embodiment of the present invention can automatically store the three-dimensional; image data created from the photographed aerial photographs one after another into the three-dimensional image database 108. When aerial photographs of the earth's surface all over the world are taken and three-dimensional image data generated therefrom is stored into the three-dimensional image database 108, the user selects a given location to which he/she desires to go (Champs Élysées in Paris or the great plain in Siberia) from all over the world and can sightsee in the three-dimensional image stereoscopic representation of the selected location.

<The Configuration of an Information Providing Server According to a Fourth Embodiment of the Present Invention>

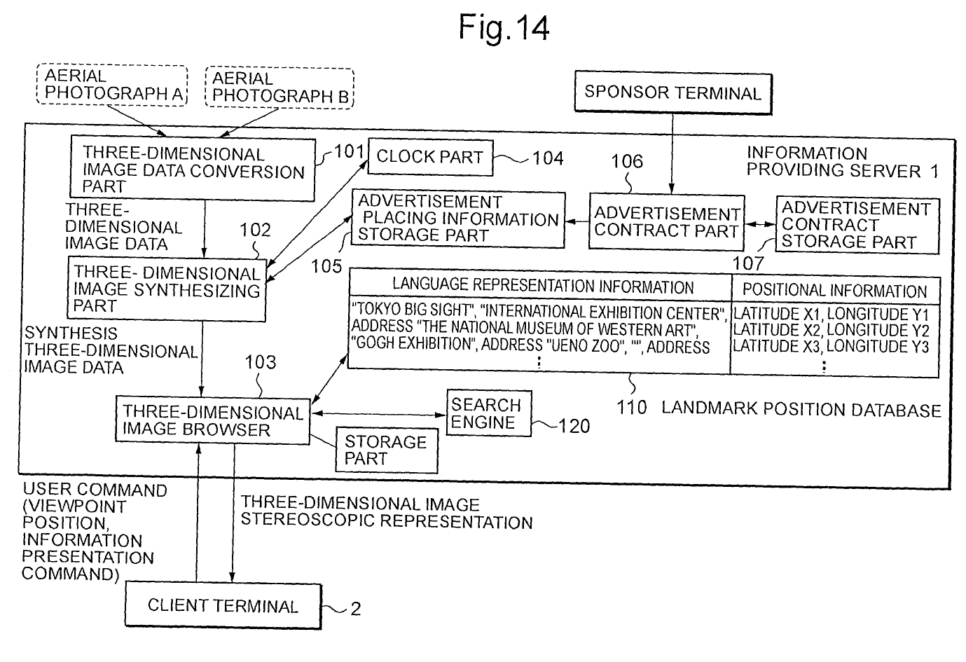

FIG. 14 shows the schematic configuration of an information providing server according to a fourth embodiment of the present invention. An information providing server 1 according to the fourth embodiment of the present invention has a three-dimensional image data conversion part 101, a three-dimension image synthesizing part 102, a three-dimensional image browser 103, a clock part 104, an advertisement placing information storage part 105, an advertisement contract part 106, an advertisement contract storage part 107, a landmark position database 110, and a search engine 120. The same components as those of the above-mentioned embodiments of the present invention are indicated by similar numerals, and the description thereof is omitted.

The landmark position database 110 holds landmark information including language representation information and positional information.

The language representation information shows information on the name or contents of a landmark which exists in a photographed area in an aerial photograph. The language representation information is of a keyword form so that the search engine 120 is available. For example, when a landmark is Tokyo Big Sight, keywords of exact addresses of Tokyo International Exhibition Center”, “Tokyo Big Sight” or “XX-ku, Tokyo” as the language representation information are listed.

The positional information shows information on the position of a landmark using the latitude and longitude. The positional information has a two-dimensional arrangement representation which can be accepted by the three-dimensional image browser 103. A recording medium of the landmark position database 110 may be either a relational database or a typical file format, and is not limited in particular.

When a keyword is inputted, the search engine 120 uses the keyword to search for link information to page data including related contents from a set of page data (e.g., a place like WWW). Such search can be realized by a search engine which is widely used by WWW (e.g., see Altavista (trademark) or Infoseek (trademark). The present invention does not particularly limit a technique for search by the search engine 120. The search engine 120 which is a search engine permitting a more intelligent process to address information can provide more suitable information.

The three-dimensional image browser 103 generates a three-dimensional image stereoscopic representation from the synthesis three-dimensional image data outputted from the three-dimensional image synthesizing part 102. The three-dimensional image browser 103 receives the synthesis three-dimensional image data outputted from the three-dimensional image synthesizing part 102 and stores once the received synthesis three-dimensional data into the storage part of the three-dimensional image browser. When a specific viewpoint position is inputted from the client terminal 2, the three-dimensional image browser 103 uses the inputted viewpoint position to generate a three-dimensional image stereoscopic representation which is then provided to client terminal. The three-dimensional image browser 103 waits again for a command input of the positional information or the viewpoint position from the client. When the user specifies a given position in the three-dimensional image stereoscopic representation to input an information presentation command from the client terminal 2, the three-dimensional image browser 103 refers to the landmark position database 110 and uses the positional information included in the landmark information and the position specified from the client terminal 2 to specify related landmark information. The three-dimensional image browser 103 outputs the language representation information included in the specified landmark to the search engine 120, and allows the search engine 120 to search for the link information using the language representation information. The three-dimensional image browser 103 sends the search result to the client terminal 2.

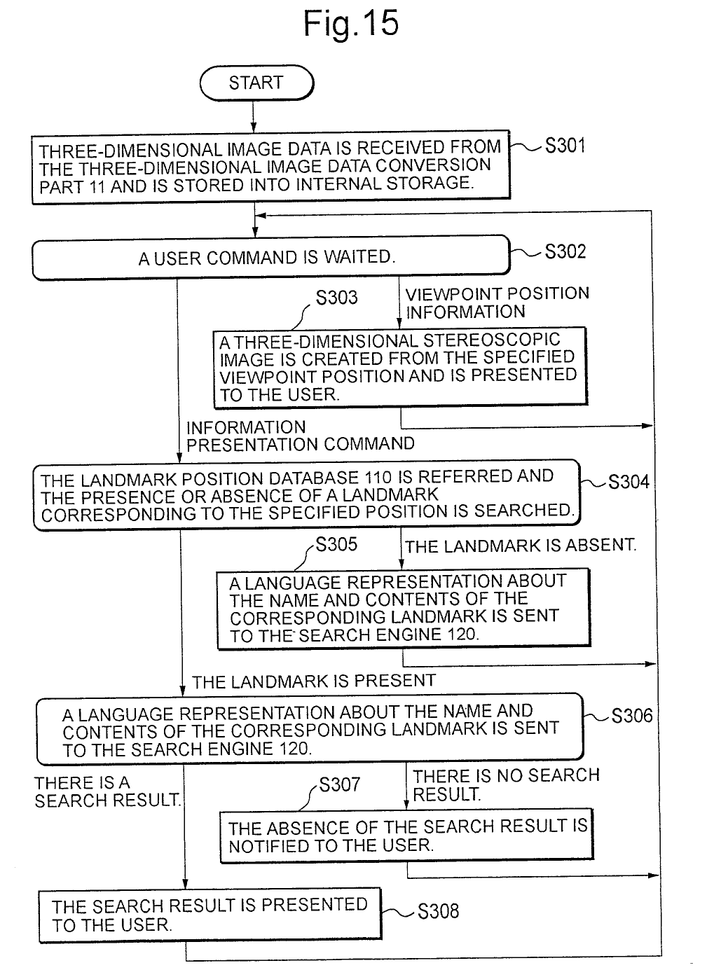

FIG. 15 shows a processing example of the three-dimensional image browser 103 according to the fourth embodiment of the present invention. The three-dimensional image browser 103 receives three-dimensional image data from the three-dimensional image data conversion part 101 to store it once into the storage part therein (step S301) and moves to a command wait from the user (step S302). When the three-dimensional image browser 103 receives a specific viewpoint position via the client terminal from the user, the three-dimensional image browser 103 creates a three-dimensional image stereoscopic image viewed from the viewpoint position which is then provided to the user (step S303). The routine is returned to step S302, and the three-dimensional image browser 103 waits again for a command from the user.

In step S302, when the user commands to provide related information on a certain position in the three-dimensional image stereoscopic representation, the three-dimensional image browser 103 refers to the landmark position database 110 to check whether landmark information corresponding to the specified certain position exists or not (step S304). When the landmark position does not exist, the three-dimensional image browser 103 notifies to the user that there is no related information of the specified position (step S305). The routine is returned to step S302.

When the landmark exists, the three-dimensional image browser 103 sends to the search engine 120 the language representation information included in the corresponding landmark information (step S306) The search engine 120 searches for related information using the language representation information. For example, when Infoseek (trademark) which is a typical search engine of WWW is used and the three-dimensional image browser 103 sends the language representation information to Infoseek (trademark), Infoseek (trademark) sends back link information of a home page of WWW related to the language representation information.

When there is no search result of the search engine 120, the three-dimensional image browser 103 notifies it to the user (step S307), and the routine is returned to step S302. When there is a search result, the three-dimensional image browser 103 provides the search result to the user (step S308) and the routine is returned to step S302.

When there is a search result, the three-dimensional image browser 103 provides the link information to the user. For example, when the user is sightseeing in the three-dimensional image stereoscopic representation, the case that the user over Ueno Zoo thinks that “This building looks like a park. What on earth is it?” is considered. In this case, the user only commands to the three-dimensional image browser 103 to show related information of the position of the entire Ueno Zoo and can receive provision of information related to Ueno Zoo.

The three-dimensional image browser 103 checks the latitude and longitude corresponding to the user's command to refer to the landmark position database 110. The three-dimensional image browser 103 checks whether landmark information having positional information including the location of the latitude and longitude exits or not. When there is no corresponding landmark information, the three-dimensional image browser 103 notifies to the user that “There is no related information”. If the three-dimensional image browser 103 refers to the landmark position database 110 and a landmark itself corresponding to the specified certain position does not exist, the three-dimensional image browser 103 notifies to the user that related landmark does not exist.

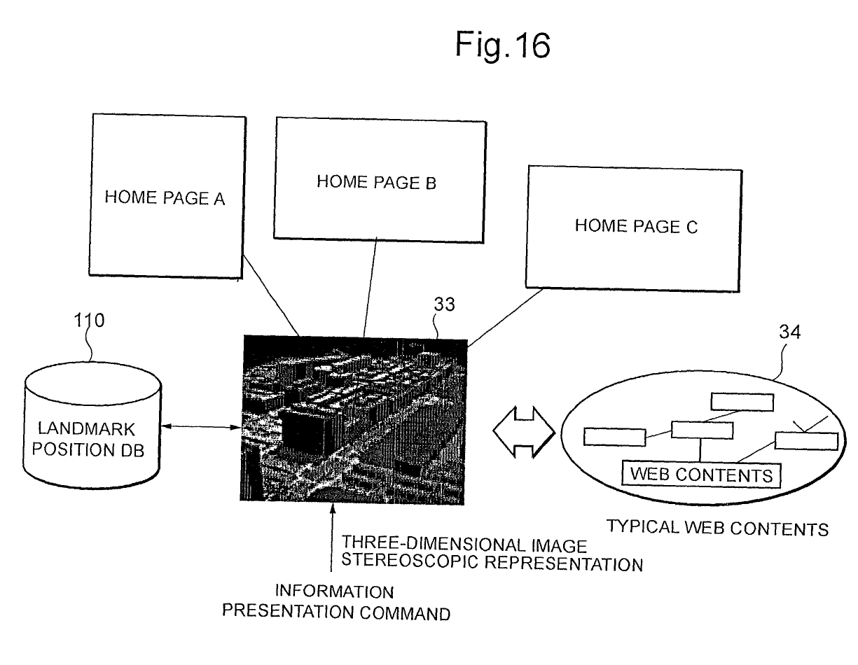

FIG. 16 is a concept view showing a state that the user specifies a landmark in a specific position in a three-dimensional image stereoscopic representation to request presentation of related information, and as a result, the related information is presented on the display part. When the user specifies a landmark in a given position while the user is sightseeing in the three-dimensional image stereoscopic representation and commands information presentation, the information providing server 1 shows link information related to the landmark. Based on the link information presented on the display part, the user can obtain information on the desired landmark (home pages A, B and C) from a typical Web contents 34.

<The Configuration of an Information Providing Server According to a Fifth Embodiment of the Present Invention>

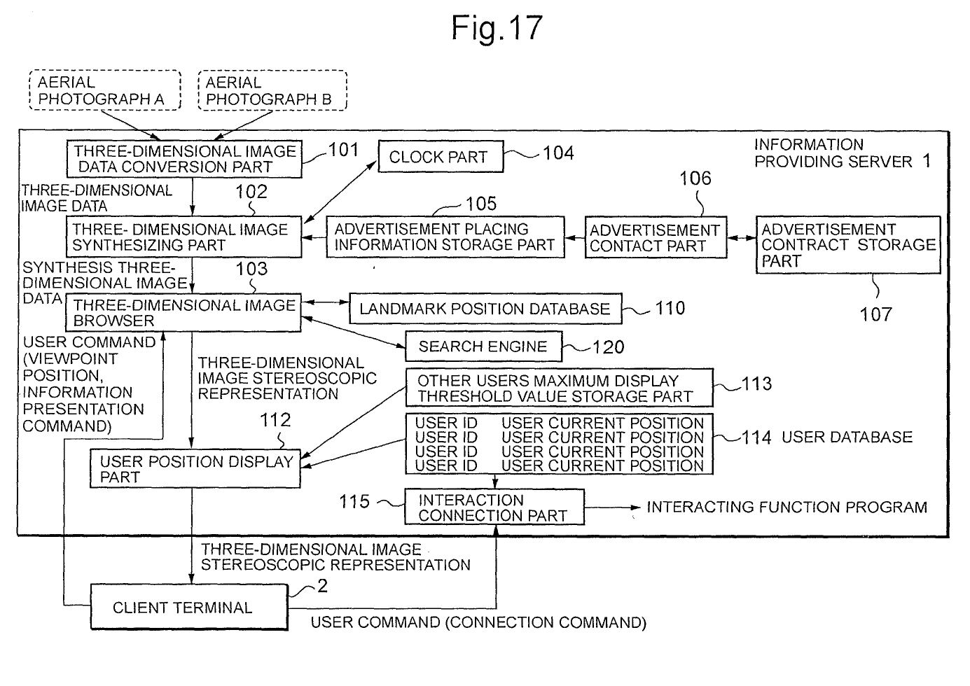

FIG. 17 shows the schematic configuration of an information providing server according to a fifth embodiment of the present invention. An information providing server 1 according to the fifth embodiment of the present invention has a three-dimensional image data conversion part 101, a three-dimension image synthesizing part 102, a three-dimensional image browser 103, a clock part 104, an advertisement placing information storage part 105, a landmark position database 110, a search engine 120, a user position display part 112, another users maximum threshold value storage part 113, a user database 114, and an interaction connection part 115. The same components as those of the above-mentioned embodiments of the present invention are indicated by similar numerals, and the description thereof is omitted.

The user database 114 stores a user ID and a user current position. The user ID identifies each user. The user current position shows the current viewpoint position of a user who receives a service from the information providing server 1 by logging in the current information providing server 1. When the information providing server 1 provides a service using the present invention by WWW, the user database 114 can be realized by the relational database on the information providing server 1. Each user performs sightseeing in the three-dimensional image stereoscopic representation on the client terminal 2 and inputs the current viewpoint position to the three-dimensional image browser 103. The three-dimensional image browser 103 sends the inputted viewpoint position to the user position display part 112 which stores the sent viewpoint position into the user database 114.

The user position display part 112 displays the user position in the three-dimensional image stereoscopic representation. The user position display part 112 adds a user position mark showing the user himself/herself to the three-dimensional image stereoscopic representation provided by the three-dimensional image browser 103. The user specifies the location of his/her own viewpoint position by the client terminal. The user position display part 112 fetches the viewpoint positions of users other than the user himself/herself from the user database 114 and displays in each of the viewpoint positions an other users position mark showing other users.

The user position display part 112 can be realized as an addition function on the three-dimensional image browser 103. A method for realizing the addition function can be realized using Java Applet, ActiveX (trademark) or a plug-in function. The viewpoint position of the user himself/herself can be obtained from the client terminal 2. For the viewpoint position of other users, the client terminal 2 performs requesting to the information providing server 1 side, so that the user position display part 112 of the information providing server 1 can obtain the current viewpoint positions of other users from the user database 114.

The other users maximum display threshold value storage part 113 stores a threshold value showing the maximum number of other users position marks displayed in the three-dimensional image stereoscopic representation. For example, when the range for sightseeing in the image stereoscopic representation is very vast like the whole world or the number of all the users is very large, the maximum number for displaying the view point positions of other users is determined and is stored into the other users maximum display threshold value storage part 113. The user position display part 112 fetches the current positions of the number of other users up to the threshold value from the user database 114 based on the threshold value stored into the other users maximum display threshold value storage part 113 (the number of the user maximum displays). As a method for fetching the current positions of the number of other users up to the threshold value, a method for sequentially fetching other users current positions near theuser's own position can be considered. When the area for sightseeing in the three-dimensional image stereoscopic representation is a small range for 1 km around or the total number of users to be displayed is small, the user position display part 112 may use a method for fetching all other users current positions positioned in the range from the user database 114.

The interaction connection part 115 provides connection between the user and others specified by the user. The user can specify the other users position marks displayed in the three-dimensional image stereoscopic representation and desire to interact with others. As the connection method, E-mail, phone, and chat can be considered.

When the user specifies the other users position marks displayed in the three-dimensional image stereoscopic representation on the client terminal 2, the client terminal notifies to the information providing server 1 that there is an interaction request. The interaction connection part 115 of the information providing server 1 checks the user IDs of the specified users from the user database 114. The interaction connection part 115 starts up an execution application of a predetermined interaction means such as E-mail and provides connection between the user and the users having the checked user IDs. A process whether the interaction is established or not or is denied from the other users side or not is performed in the started execution application.

The information providing server 1 according to the fifth embodiment of the present invention allows the user to view other persons other than the user sightseeing in the three-dimensional image stereoscopic representation. The user can recognize what sort of people are searching and in what place they are searching so as to double fun. Further, the information providing server according to the fifth embodiment of the present invention allows the user to connect to and interact with others displayed in the three-dimensional image stereoscopic representation. The user can make a tour of famous old spots with persons viewing the same location and can get to know each other. For example, when a certain person views the periphery of Leonardo da Vinci Museum in Vinci village in the suburbs of Florence in Italy and another person appears, the user can predict that another person also likes Leonardo da Vinci like the user. The user can provide connection between the user and the another person for interaction and may make friends with the another person.

<The Configuration of an Information Providing Server According to a Sixth Embodiment of the Present Invention>

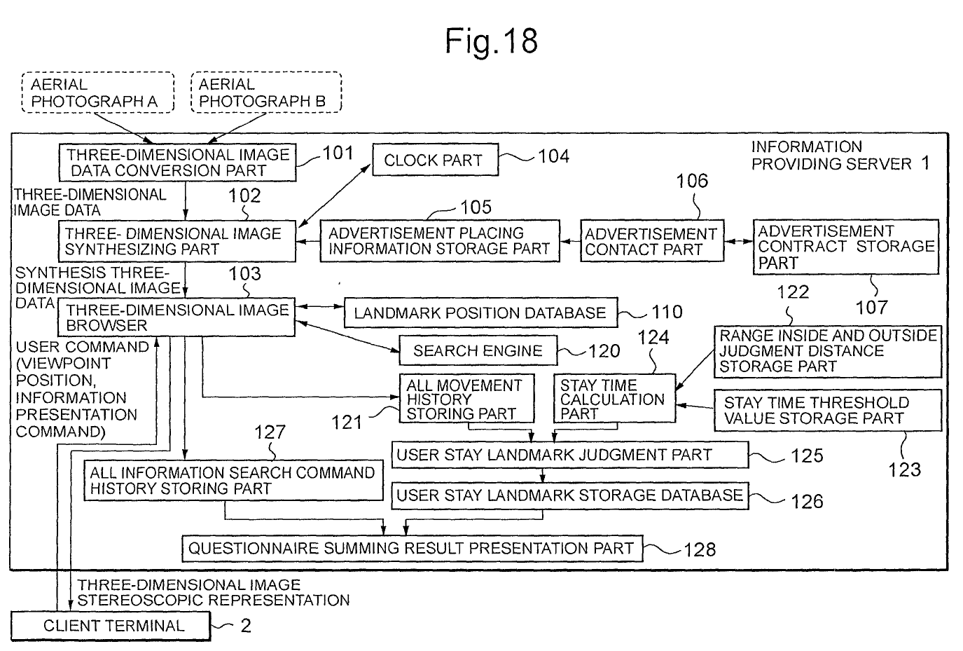

FIG. 18 shows the schematic configuration of an information providing server according to a sixth embodiment of the present invention. An information providing server 1 according to the sixth embodiment of the present invention has a three-dimensional image data conversion part 101, a three-dimension image synthesizing part 102, a three-dimensional image browser 103, a clock part 104, an advertisement placing information storage part 105, a landmark position database 110, a search engine 120, an all movement history storing part 121, a range inside and outside judgment distance storage part 122, a stay time threshold value storage part 123, a stay time calculation part 124, a user stay landmark judgment part 125, a user stay landmark storage database 126, an all information search command history storing part 127, and a questionnaire summing result presentation part 128. The same components as those of the above-mentioned embodiments of the present invention are indicated by similar numerals, and the description thereof is omitted.

The all movement history storing part 121 stores movement history information including the viewpoint position of the user and the time.

The range inside and outside judgment distance storage part 122 defines a range around a landmark which is a judgment reference for judging that the user is interested in a landmark. For example, when the user is within a radius of 500 m from a certain landmark and the user is assumed to be interested in the landmark, the range inside and outside judgment distance storage part 122 stores a value of “within a radius of 500 m”.

The stay time threshold value storage part 123 stores a stay time threshold value showing a stay time to stay around a landmark which is a judgment reference for judging that the user is interested in a landmark. For example, when the user stays around a certain landmark for over one minute and the user is assumed to be interested in the landmark, the stay time threshold value storage part 123 stores a time of the “one minute”.

The user stay landmark storage database 126 stores a landmark stay history including a landmark where the user stays and the stay time.

The all information search command history storing part 127 records an information provision command history including the name of a landmark in which the user commands related information provision and time in which the user commands related information provision.

The stay time calculation part 124 refers to the landmark position database 110 and extracts the landmark position through which the user passes and the time from the movement history information stored by the all movement history storing part 121. The stay time calculation part 124 calculates the first time and the last time when the viewpoint position of the user is within the definition of the periphery stored in the range inside and outside judgment distance storage part 122 from a certain landmark.

The user stay landmark judgment part 125 compares a difference between the last time and the first time calculated by the stay time calculation part 124 with the threshold value stored in the stay time threshold value storage part 123. When the difference between the times is above the threshold value, the user stay landmark judgment part 125 judges that the user stays at the landmark and stores the landmark name and the difference value into the user stay landmark storage database 126.

When the manager commands to provide the summing result, the questionnaire summing result provision part 128 outputs the landmark stay history of the user stay landmark storage database 126 or the information provision command history of the all information search command history storing part 127.

The information providing server according to the sixth embodiment of the present invention can record all information showing the types of users and their visiting time and location, and sum up the social trends showing the types of people and their gathering location. For example, the information providing server 1 grasps all the information that how many people goes to see cherry blossoms of Yoshino, Nara Prefecture on April 30 when spring cherry blossoms are in full blossom or where the people visit after seeing the cherry blossoms of Yoshino. The information providing server 1 provides the information so that the user who receives information provision can make very strong marketing information based on the information.

The information providing server according to the sixth embodiment of the present invention allows the manager of the information providing server 1 to propose an effective advertisement placing position by presenting the marketing result to the sponsor side and differentiate an advertisement placing fee in an area where users gather from that of other areas.

When the user uses the information providing server 1, the user is admitted to use it anonymously. The reason is that the manager of the information providing server 1 knows about where the user performs searching in a state that existence of the user is apparent is an invasion of the user's privacy and the user is difficult to admit it. This enables the user side to use the information providing server 1 with a sense of security.

The information providing server 1 can report to a sponsor as an advertisement placing person that how many users look at an advertisement.

In the above-mentioned fourth to sixth embodiments of the present invention, the position input type three-dimensional image synthesizing part may be used in place of the three-dimensional image synthesizing part 102, or the position output type three-dimensional image browser may be used in place of the three-dimensional image browser 103.

The system configurations of the above-mentioned embodiments is a client/server type distribution process system, but the present invention is not limited to these configurations. In other words, various modifications can be executed within the range without deviating from the purpose of the present invention.

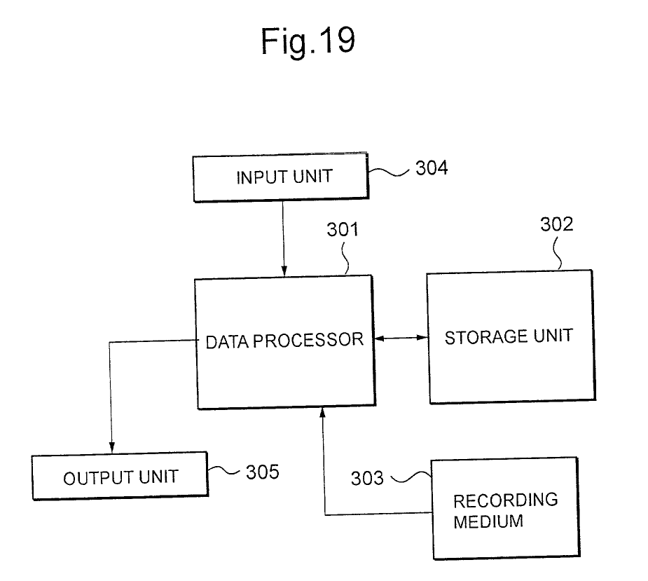

The information providing server and client can be realized by the configuration shown in FIG. 19. Referring to FIG. 19, the information providing server 1 in this embodiment has a data processor 301 configured by a CPU, a storage unit 302 configured by a memory whose read and write time is short, a recording medium 303 such as a hard disk having a large storage capacity, and an input unit 304 and an output unit 305 which control sending/receiving of data to/from an external device via a line. In this configuration, for example, with respect to the information providing server 1 shown in FIG. 2, the data processor 301 generates, executes and operates the three-dimensional image data conversion part 101, the three-dimensional image synthesizing part 102 and the three-dimensional image browser 103. A program for generating, executing and operating these parts is stored onto the recording medium 302.

When the data processor 301 generates, executes and operates the three-dimensional image data conversion part 101, the three-dimensional image synthesizing part 102 and the three-dimensional image browser 103, the data processor 301 reads and executes each of the programs from the recording medium 302. The advertisement placing information storage part 105, the advertisement contract storage part 107, and the three-dimensional image database 108 are stored into the storage unit 302 or the recording medium 303.

Referring to FIG. 19, the client terminal in this embodiment has a data processor 301 configured by a CPU, a storage unit 302 configured by a memory whose read and write time is short, a recording medium 303 such as a hard disk having a large storage capacity, and an input unit 304 and an output unit 305 which control sending/receiving of data to/from an external device via a line. In this configuration, for example, with respect to the client terminal 2 shown in FIG. 10, the data processor 301 generates, executes and operates the position output type three-dimensional image browser 201. A program for generating, executing and operating the position output type three-dimensional image browser 201 is stored onto the recording medium 302.

When the data processor 301 generates, executes and operates the position output type three-dimensional image browser 201, the data processor 301 reads and executes the program from the recording medium 302. As described above, the system of the present invention can replace a manual operation for making a map using an artificial satellite image or aerial photographs with a mechanical operation and automatically synthesize and output advertisement information. The present invention can easily update map information or advertisement information. For example, using IKONOS, the entire surface of the earth can be updated every week. Since map information is automatically updated using an artificial image satellite, the information providing server can provide the user with latest map information on an area where rebuilding of a building in the center of a city is frequent together advertisement information.

Much information related to information on weather or volcanoes is provided on WWW by an information provider. Each information provider updates the related information to latest information. Without updating the related information by the manager of the new information providing server 1, the present invention allows the information providing server 1 to provide latest information within the related information in which the user is interested. In the information providing server of the prior art method, the server manager must paste related information onto a map. In order that the information providing server of the prior art method can provide latest information, the manager himself/herself must always update information manually. In consideration of an actual operation, such an operation is not realistic. The present invention can clear the problem and provide latest information to the user.

Since the information providing server 1 of the present invention generates and provides a three-dimensional stereoscopic image corresponding to change of the viewpoint position from the user, the user can search for related information while the user is sightseeing in the three-dimensional stereoscopic image. The information providing server 1 of the present invention can give the user a visual effect which is much more enjoyable than the information search from the prior art map.

Further, the present invention allows the user to use the information providing server 1 for free and can establish the operation of the information providing server 1 in business. This can provide the user with a three-dimensional aerial sightseeing service on the Internet, but to establish it as business, the flow of money must be created. Of course, collecting a fee from the user is most direct. However, on the Internet, there are few successful examples in business in which a fee is collected directly from the user. The present invention employs a form in which an advertisement placing fee is collected from an advertisement placing person like a commercial TV broadcasting station and can make a three-dimensional aerial sightseeing service by the advertisement placing fee into business. In other words, provision of an expensive three-dimensional aerial sightseeing service can be provided to the user for free. The information providing server 1 allows the three-dimensional aerial sightseeing user who searches for information in the three-dimensional aerial sightseeing service to look at the advertisement irrespective of his/her own intension. The information providing server 1 of the present invention gives a large merit to the advertisement provider.

The manager of the information providing server 1 changes an advertisement placing fee corresponding to a location desired to place an advertisement, so that the business range can be increased. For example, the sponsor side compares a placing fee decided by a placed location and a placing period with his/her own budget, and selects the placed location corresponding to the budget and requests the information providing server 1 to place an advertisement.

When the user of the present invention looks at an advertisement unconsciously placed while the user is walking in the air by the three-dimensional aerial sightseeing service and thinks of purchasing of the product, the user can use the Internet shopping there. In other words, although the user confirms a placed advertisement handbill and then goes shopping for the product as in the prior art, the user can take a procedure for purchasing the product on the client terminal.

The above embodiments are preferable embodiments of the present invention, and various modifications can be executed within the range without deviating from the purpose of the present invention.

What is claimed is:

1. An information providing server comprising:
three-dimensional image data storage means for storing three-dimensional image data generated based on image information in which a physical position is clearly described and in which the same area is photographed from different locations, and storing positional information showing the position of said three-dimensional image data;
advertisement placing information storage means for storing advertisement placing information including at least a placing period and a placed location of an advertisement by adding an ID for each advertisement; and
three-dimensional image synthesizing means for reading the three-dimensional image data from said three-dimensional image data storage means based on browsing location specification information, reading from said advertisement placing information storage means said advertisement placing information having said placing period including the current date data and said placed location included in said three-dimensional image data read based on said browsing location specification information, and synthesizing said read three-dimensional image data with said advertisement placing information to generate synthesis three-dimensional image data.

2. An information providing server comprising:
three-dimensional image data storage means for storing three-dimensional image data generated based on image information in which a physical position is clearly described and in which the same area is photographed from different locations, and storing positional information showing the position of said three-dimensional image data;
advertisement placing information storage means for storing advertisement placing information including at least a placing period and a placed location of an advertisement by adding an ID for each advertisement;
three-dimensional image synthesizing means for reading the three-dimensional image data from said three-dimensional image data storage means based on browsing location specification information, reading from said advertisement placing information storage means said advertisement placing information having said placing period including the current date data and said placed location included in said three-dimensional image data read based on said browsing location specification information, and synthesizing said read three-dimensional image data with said advertisement placing information to generate synthesis three-dimensional image data;
advertisement contract storage means for storing contract information including an ID added to said advertisement placing information, the name of an advertisement placing person who desires to place an advertisement, and a contract money amount; and
advertisement contract means for executing a contract process of an advertisement placing request upon reception of said advertisement placing request from said advertisement placing person and updating said advertisement placing information stored in said advertisement placing information storage means based on said contract information stored in said advertisement contract storage means.

3. The information providing server according to claim 1 or 2, further comprising three-dimensional image data conversion means for generating three-dimensional image data based on image information in which the same area is photographed from different locations and in which a physical position is clearly described.

4. An information providing server comprising:
three-dimensional image data storage means for storing three-dimensional image data generated based on image information in which a physical position is clearly described and in which the same area is photographed from different locations, and storing positional information showing the position of said three-dimensional image data;
advertisement placing information storage means for storing advertisement placing information including at least a placing period and a placed location of an advertisement by adding an ID for each advertisement;
three-dimensional image synthesizing means for reading the three-dimensional image data from said three-dimensional image data storage means based on browsing location specification information, reading from said advertisement placing information storage means said advertisement placing information having said placing period including the current date data and said placed location included in said three-dimensional image data read based on said browsing location specification information, and synthesizing said read three-dimensional image data with said advertisement placing information to generate synthesis three-dimensional image data; and
three-dimensional image browser means for generating, based on a desired view point position, a three-dimensional image stereoscopic representation from said synthesis three-dimensional image data outputted from said three-dimensional image synthesizing means.

5. An information providing server comprising:
three-dimensional image data storage means for storing three-dimensional image data generated based on image information in which a physical position is clearly described and in which the same area is photographed from different locations, and storing positional information showing the position of said three-dimensional image data;
advertisement placing information storage means for storing advertisement placing information including at least a placing period and a placed location of an advertisement by adding an ID for each advertisement;
three-dimensional image synthesizing means for reading the three-dimensional image data from said three-dimensional image data storage means based on browsing location specification information, reading from said advertisement placing information storage means said advertisement placing information having said placing period including the current date data and said placed location included in said three-dimensional image data read based on said browsing location specification information, and synthesizing said read three-dimensional image data with said advertisement placing information to generate synthesis three-dimensional image data;
three-dimensional image browser means for generating, based on a desired viewpoint position, a three-dimensional image stereoscopic representation from said synthesis three-dimensional image data outputted from said three-dimensional image synthesizing means;
advertisement contract storage means for storing contract information including an ID added to said advertisement placing information, the name of an advertisement placing person who desires to place an advertisement, and a contract money amount; and
advertisement contract means for executing a contract process of an advertisement placing request upon reception of said advertisement placing request from said advertisement placing person and updating said advertisement placing information stored in said advertisement placing information storage means based on said contract information stored in said advertisement contract storage means.

6. The information providing server according to claim 4 or 5, further comprising three-dimensional image data conversion means for generating three-dimensional image data based on image information in which a physical position is clearly described and in which the same area is photographed from different locations.

7. The information providing server according to claim 4 or 5, further comprising:
user data storage means for recording the ID of a user and the viewpoint position of said user;
other users maximum display threshold value storage means for storing an other users maximum display threshold value for defining a threshold value to display the maximum number of viewpoint positions of other users when displaying the viewpoint positions of the other users;
user position display means for adding a user position mark showing the user to the viewpoint position of the user in said three-dimensional image stereoscopic representation provided to said user, fetching from data stored in said user data storage means the viewpoint positions of said other users and said user IDs up to said threshold value defined by said other users maximum display threshold value in the order close to the viewpoint position of said user, and adding other users position marks showing said other users to said viewpoint positions; and
interaction connection means for regarding, as persons to interact with, the user IDs of said other users corresponding to given specified other users position marks when said user specifies said given other users position marks and starting an interacting function program to provide connection.

8. An information providing server comprising:
three-dimensional image data storage means for storing three-dimensional image data generated based on image information in which a physical position is clearly described and in which the same area is photographed from different locations, and storing positional information showing the position of said three-dimensional image data;
advertisement placing information storage means for storing advertisement placing information including at least a placing period and a placed location of an advertisement by adding an ID for each advertisement;
three-dimensional image synthesizing means for reading the three-dimensional image data from said three-dimensional image data storage means based on browsing location specification information, reading from said advertisement placing information storage means said advertisement placing information having said placing period including the current date data and said placed location included in said three-dimensional image data read based on said browsing location specification information, and synthesizing said read three-dimensional image data with said advertisement placing information to generate synthesis three-dimensional image data;
three-dimensional image browser means for generating, based on a desired viewpoint position, a three-dimensional image stereoscopic representation from said synthesis three-dimensional image data outputted from said three-dimensional image synthesizing means;
landmark position storage means for storing landmark information including a langrage representation about the name or contents corresponding to a landmark existing in said three-dimensional image data and positional information on the position of said landmark; and
search engine means for searching for page data including the contents related to a keyword from a set of page data when said keyword is given as input and generating link information to said page data, wherein said three-dimensional image browser means refers to said positional information included in said landmark information of said landmark position storage means when related information presentation related to the position is commanded, specifies the corresponding landmark information, outputs said language representation information of the landmark information to said search engine means, and allows said search engine means to generate link information of page data related to the landmark information.

9. An information providing server comprising:
three-dimensional image data storage means for storing three-dimensional image data generated based on image information in which a physical position is clearly described and in which the same area is photographed from different locations, and storing positional information showing the position of said three-dimensional image data;
advertisement placing information storage means for storing advertisement placing information including at least a placing period and a placed location of an advertisement by adding an ID for each advertisement;
three-dimensional image synthesizing means for reading the three-dimensional image data from said three-dimensional image data storage means based on browsing location specification information, reading from said advertisement placing information storage means said advertisement placing information having said placing period including the current date data and said placed location included in said three-dimensional image data read based on said browsing location specification information, and synthesizing said read three-dimensional image data with said advertisement placing information to generate synthesis three-dimensional image data;
three-dimensional image browser means for generating, based on a desired viewpoint position, a three-dimensional image stereoscopic representation from said synthesis three-dimensional image data outputted from said three-dimensional image synthesizing means;
landmark position storage means for storing landmark information including a langrage representation about the name or contents corresponding to a landmark existing in said three-dimensional image data and positional information on the position of said landmark;
search engine means for searching for page data including the contents related to a keyword from a set of page data when said keyword is given as input and generating link information to said page data;
user stay landmark storage means for storing a landmark stay history including said landmark where a user stays and the stay time at the landmark;
all movement history storing means for recording a movement history including the viewpoint position of said user and the time;
stay time threshold value storage means for storing a stay time threshold value showing time to stay around a landmark necessary for judging that said user is interested in said landmark;
range inside and outside judgment distance storage means for storing range inside and outside judgment distance information showing definition of the peripheral position from the position of a landmark necessary for judging that said user is interested in said landmark;
stay time calculation means for extracting said landmark information from said landmark position storage means, using positional information of the landmark information and said range inside and outside judgment distance information stored in said range inside and outside judgment distance storage means to extract from said all movement history storing means said movement history when the viewpoint position of said user is within the range of the peripheral position defined by said range inside and outside judgment distance information from said extracted landmark position, and using the extracted movement history to calculate the first time and the last time in which the viewpoint position of said user passes through said landmark; and
user stay landmark judgment means for comparing a stay time which is a difference between said last time and said first time calculated by said stay time calculation means with said stay time threshold value stored in said stay time threshold value storage means, and when said stay time is above said stay time threshold value, using said language representation information of said landmark information to store said landmark name and said stay time into said user stay landmark storage means,
wherein said three-dimensional image browser means refers to said positional information included in said landmark information of said landmark position storage means when related information presentation related to the position is commanded, specifies the corresponding landmark information, outputs said language representation information of the landmark information to said search engine means, and allows said search engine means to generate link information of page data related to the landmark information.

10. The information providing server according to claim 9, further comprising:
all information search command history storing means for recording an information presentation command history including the landmark name in which said user commands related information presentation related to the position and the time; and
questionnaire summing result presentation means for outputting said landmark stay history of said user stay landmark storage means or said information presentation command history of said all information search command history storing means when a manager commands to present the summing result.

11. An information providing client, wherein
provision of information showing a viewpoint position is requested to an information providing server for storing advertisement placing information including at least a placing period of an advertisement desired to be placed by adding an ID for each advertisement;
said information providing server is allowed to synthesize three-dimensional image data generated based on image information in which a physical position is clearly described and in which the same area is photographed from different locations with said advertisement placing information to generate synthesis three-dimensional image data when said placing period included in said stored advertisement placing information includes the current date, and to use said viewpoint position to generate a three-dimensional image stereoscopic representation from the synthesis three-dimensional image data; and
the three-dimensional image stereoscopic representation is received and displayed.

12. An information providing client comprising:
a three-dimensional image browser which stores three-dimensional image data generated based on image information in which a physical position is clearly described and in which the same area is photographed from different locations associated with positional information showing the position of the three-dimensional image data and further performs a browsing location specification for specifying a desired location to be browsed to an information providing server for storing advertisement placing information including at least a placing period and a placed location of an advertisement by adding an ID for each advertisement, and which allows said information providing server to read the corresponding three-dimensional image data from said three-dimensional image data based on said browsing location specification, to read from said advertisement placing information said advertisement placing information having said placing period including the current date data and said placed location included in said read three-dimensional image data and to synthesize said read three-dimensional image data with said advertisement placing information to generate synthesis three-dimensional image data, and receives the synthesis three-dimensional image data to generate a three-dimensional image stereoscopic representation based on a viewpoint position;
an input part for outputting said viewpoint position to said three-dimensional image browser; and
a display part for receiving said three-dimensional image stereoscopic representation from said three-dimensional image browser to display it.

13. The information providing client according to claim 11 or 12, wherein
said information providing server stores landmark information including a langrage representation about the name or contents corresponding to a landmark existing in said three-dimensional image data and positional information on the position of said landmark;
a related information provision request showing a position for requesting related information provision is performed to said information providing server; and
said information providing server is allowed to refer to said positional information included in said stored landmark information, to specify the corresponding landmark information, to use said language representation information of the landmark information to search for page data including the contents related to the language representation information from a set of the page data, and to generate link information to said page data.

14. The information providing client according to claim 11 or 12, wherein
when said information providing server records the ID of a user and the viewpoint position of said user and further displays viewpoint positions of other users, an other users display request for requesting display of other users in said three-dimensional image stereoscopic representation is performed to said information providing server for storing an other users maximum display threshold value for defining a threshold value to display the maximum number of the viewpoint positions of the other users;
said information providing server is allowed to add and display a user position mark showing the user to the viewpoint position of the user in said three-dimensional image stereoscopic representation, to fetch from said stored user viewpoint position said viewpoint positions of the other users and said user IDs up to said stored threshold value in the order close to said viewpoint position of the user, and to add and display other users position marks showing said other users to said viewpoint position in said three-dimensional image stereoscopic representation and further an interaction connection request for specifying said other users position marks displayed in the three-dimensional image stereoscopic representation to desire to interact with said other users is performed to said information providing server; and
said information providing server is allowed to start an interacting function program to provide connection between the user and said other users corresponding to said specified other users position marks.

15. An information providing client, wherein
an advertisement placing request for requesting placement of an advertisement is performed to an information providing server for storing advertisement placing information including at least a placing period of an advertisement by adding an ID for each advertisement; and
said information providing server is allowed to execute a contract process of the advertisement placing request, to update said stored advertisement placing information based on the contents of the contract process, to synthesize, at an information providing request form another client, three-dimensional image data generated based on image information in which a physical position is clearly described and in which the same area is photographed from different locations with said advertisement placing information to generate synthesis three-dimensional image data when said placing period included in said stored advertisement placing information includes the current date, and to send the synthesis three-dimensional image data to the another client.

16. An information providing system processing method, wherein
an information providing server stores three-dimensional image data generated based on image information in which a physical position is clearly described and in which the same area is photographed from different locations and stores positional information showing the position of said three-dimensional image data and further stores advertisement placing information including at least a placing period and a placed location of an advertisement by adding an ID for each advertisement;
an information providing client performs to said information providing server a browsing location specification for specifying a desired browsing location;
said information providing server reads the corresponding three-dimensional image data from said three-dimensional image data based on said browsing location specification, reads from stored said advertisement placing information said advertisement placing information having said placing period including the current date data and said placed location included in said three-dimensional image data read based on said browsing location specification, and synthesizes said read three-dimensional image data with said advertisement placing information to generate synthesis three-dimensional image data which is then outputted to said information providing client; and
said information providing client receives said synthesis three-dimensional image data to generate a three-dimensional image stereoscopic representation based on the viewpoint position.

17. An information providing system processing method, wherein
an information providing server stores three-dimensional image data generated based on image information in which a physical position is clearly described and in which the same area is photographed from different locations and stores positional information showing the position of said three-dimensional image data and further stores advertisement placing information including at least a placing period and a placed location of an advertisement by adding an ID for each advertisement;
an information providing client for advertisement provision performs to said information providing server an advertisement placing request for requesting placement of an advertisement;
said information providing server receives said advertisement placing request, executes a contract process of the advertisement placing request, and updates said advertisement placing information stored based on the contents of the contract process;
the information providing client performs to said information providing server a browsing location specification for specifying a desired browsing location;
said information providing server reads the corresponding three-dimensional image data from said three-dimensional image data based on said browsing location specification, reads from said advertisement placing information said advertisement placing information having said placing period including the current date data and said placed location included in said three-dimensional image data read based on said browsing location specification, and synthesizes said read three-dimensional image data with said advertisement placing information to generate synthesis three-dimensional image data which is then outputted to said information providing client; and
said information providing client receives said synthesis three-dimensional image data to generate a three-dimensional image stereoscopic representation based on the viewpoint position.

18. The information providing system processing method according to claim 16 or 17, wherein
said information providing server records the ID of a user and the viewpoint position of said user and further stores an other users maximum display threshold value for defining a threshold value to display the maximum number of the viewpoint positions of the other users when displaying the viewpoint positions of the other users;
said information providing client performs an other users display request for requesting other users display in said three-dimensional image stereoscopic representation;
said information providing server receives said other users display request, adds and displays a user position mark showing the user to the viewpoint position of the user to said three-dimensional image stereoscopic representation, fetches said viewpoint positions of the other users and said user IDs up to said threshold value defined by said other users maximum display threshold value in the order close to the viewpoint position of said user, and adds and displays other users position marks showing said other users to said viewpoint position in said three-dimensional image stereoscopic representation;
said information providing client performs an interaction connection request for specifying said other users position marks displayed in the three-dimensional image stereoscopic representation to desire to interact with said other users; and
said information providing server receives said interaction connection request which specifies said other users position marks, and regards, as persons to interact with, the user IDs of said other users corresponding to said specified other users position marks to start up an interacting function program to provide connection.

19. An information providing system processing method, wherein
an information providing server stores three-dimensional image data generated based on image information in which a physical position is clearly described and in which the same area is photographed from different locations and stores positional information showing the position of said three-dimensional image data and further stores advertisement placing information including at least a placing period and a placed location of an advertisement by adding an ID for each advertisement;
an information providing client performs to said information providing server a browsing location specification for specifying a desired browsing location;
said information providing server reads the corresponding three-dimensional image data from said three-dimensional image data based on said browsing location specification, reads said advertisement placing information having said placing period including the current date data and said placed location included in said three-dimensional image data read based on said browsing location specification, and synthesizes said read three-dimensional image data with said advertisement placing information to generate synthesis three-dimensional image data which is then outputted to said information providing client;
said information providing client receives said synthesis three-dimensional image data to generate a three-dimensional image stereoscopic representation based on a viewpoint position;
said information providing server stores landmark information including a langrage representation about the name or contents corresponding to a landmark existing in said three-dimensional image data and positional information on the position of said landmark;
said information providing client performs a related information provision request showing a position for requesting related information provision; and
said information providing server refers to said positional information included in the landmark information stored in said landmark position storage step, specifies the corresponding landmark information, uses said language representation information of the landmark information to search for page data including the contents related to the language representation information from a set of page data, and generates link information to said page data.

20. The information providing system processing method according to claim 19, wherein
said information providing server records a movement history including the viewpoint position of said user and the time, stores a stay time threshold value showing time to stay around a landmark necessary for judging that said user is interested in said landmark, stores range inside and outside judgment distance information showing definition of the peripheral position from the position of a landmark necessary for judging that said user is interested in said landmark, uses positional information in said stored landmark information and said stored range inside and outside judgment distance information to extract said movement history when the viewpoint position of said user is within the range of the peripheral position defined by said range inside and outside judgment distance information from said extracted landmark position, uses the extracted movement history to calculate the first time and the last time in which the viewpoint position of said user passes through said landmark, compares a stay time which is a difference between said last time and said first time calculated with said stored stay time threshold value, when said stay time is above said stay time threshold value, uses said language representation information of said landmark information to store a landmark stay history including said landmark name and said stay time, and records an information presentation command history including a landmark name in which said user specifies related information presentation about the position and the time;
said information providing client performs a summing result presentation request for commanding to present the summing result; and
said information providing server receives said summing result presentation request and outputs said stored landmark stay history or said stored information presentation command history.

21. A recording medium which records a program for a server for allowing a computer to execute:
a three-dimensional image data storage process for storing three-dimensional image data generated based on image information in which a physical position is clearly described and in which the same area is photographed from different locations, and storing positional information showing the position of said three-dimensional image data;
an advertisement placing information storage process for storing advertisement placing information including at least a placing period and a placed location of an advertisement by adding an ID for each advertisement; and
a three-dimensional image synthesizing process for reading the three-dimensional image data from said three-dimensional image data storage means based on browsing location specification information, reading from said advertisement placing information storage means said advertisement placing information having said placing period including the current date data and said placed location included in said three-dimensional image data read based on said browsing location specification information, and synthesizing said read three-dimensional image data with said advertisement placing information to generate synthesis three-dimensional image data.

22. A recording medium which records a program for a server for allowing a computer to execute:
a three-dimensional image data storage process for storing three-dimensional image data generated based on image information in which a physical position is clearly described and in which the same area is photographed from different locations ,and storing positional information showing the position of said three-dimensional image data;
an advertisement placing information storage process for storing advertisement placing information including at least a placing period and a placed location of an advertisement by adding an ID for each advertisement;
a three-dimensional image synthesizing process for reading the three-dimensional image data from said three-dimensional image data storage means based on browsing location specification information, reading from said advertisement placing information storage means said advertisement placing information having said placing period including the current date data and said placed location included in said three-dimensional image data read based on said browsing location specification information, and synthesizing said read three-dimensional image data with said advertisement placing information to generate synthesis three-dimensional image data;
an advertisement contract storage process for storing contract information including an ID added to said advertisement placing information, the name of an advertisement placing person who desires to place an advertisement, and a contract money amount; and
an advertisement contract process for executing a contract process of an advertisement placing request upon reception of said advertisement placing request from said advertisement placing person and updating said advertisement placing information stored in said advertisement placing information storage means based on said contract information stored in said advertisement contract storage means.

23. A recording medium which records a program for a server for allowing a computer to execute:
a three-dimensional image data storage process for storing three-dimensional image data generated based on image information in which a physical position is clearly described and in which the same area is photographed from different locations, and storing positional information showing the position of said three-dimensional image data;
an advertisement placing information storage process for storing advertisement placing information including at least a placing period and a placed location of an advertisement by adding an ID for each advertisement;
a three-dimensional image synthesizing process for reading the three-dimensional image data based on browsing location specification information, reading said advertisement placing information having said placing period including the current date data and said placed location included in said three-dimensional image data read based on said browsing location specification information, and synthesizing said read three-dimensional image data with said advertisement placing information to generate synthesis three-dimensional image data; and
a three-dimensional image browser process for generating, based on a desired viewpoint position, a three-dimensional image stereoscopic representation from said synthesis three-dimensional image data outputted from said three-dimensional image synthesizing means.

24. A recording medium which records a program for a server for allowing a computer to execute:
a three-dimensional image data storage process for storing three-dimensional image data generated based on image information in which a physical position is clearly described and in which the same area is photographed from different locations, and storing positional information showing the position of said three-dimensional image data;
an advertisement placing information storage process for storing advertisement placing information including at least a placing period and a placed location of an advertisement by adding an ID for each advertisement;
a three-dimensional image synthesizing process for reading the three-dimensional image data based on browsing location specification information, reading said advertisement placing information having said placing period including the current date data and said placed location included in said three-dimensional image data read based on said browsing location specification information, and synthesizing said read three-dimensional image data with said advertisement placing information to generate synthesis three-dimensional image data;
a three-dimensional image browser process for generating, based on a desired viewpoint position, a three-dimensional image stereoscopic representation from said synthesis three-dimensional image data outputted from said three-dimensional image synthesizing means;
an advertisement contract storage process for storing contract information including an ID added to said advertisement placing information, the name of an advertisement placing person who desires to place an advertisement, and a contract money amount; and
an advertisement contract process for executing a contract process of an advertisement placing request upon reception of said advertisement placing request from said advertisement placing person and updating said advertisement placing information stored in said advertisement placing information storage means based on said contract information stored in said advertisement contract storage means.

25. A recording medium which records a program for a client for allowing a computer to execute:
a process for requesting to provide information showing a viewpoint position to an information providing server for storing advertisement placing information including at least a placing period of an advertisement desired to be placed by adding an ID for each advertisement; and
a process for allowing said information providing server to synthesize three-dimensional image data generated based on image information in which a physical position is clearly described and the same area is photographed from different locations with said advertisement placing information to generate synthesis three-dimensional image data when said placing period included in said stored advertisement placing information includes the current date and to use said viewpoint position to generate a three-dimensional image stereoscopic representation from the synthesis three-dimensional image data and for receiving and displaying the three-dimensional image stereoscopic representation.

26. A recording medium which records a program for a client for allowing a computer to execute:
a three-dimensional image browser process which stores three-dimensional image data generated based on image information in which a physical position is clearly described and in which the same area is photographed from different locations associated with positional information showing the position of the three-dimensional image data and further performs a browsing location specification for specifying a desired location to be browsed to an information providing server for storing advertisement placing information including at least a placing period and a placed location of an advertisement by adding an ID for each advertisement and which allows said information providing server to read the corresponding three-dimensional image data from said three-dimensional image data based on said browsing location specification, to read from said advertisement placing information said advertisement placing information having said placing period including the current date data and said placed location included in said read three-dimensional image data and to synthesize said read three-dimensional image data with said advertisement placing information to generate synthesis three-dimensional image data, and receives the synthesis three-dimensional image data to generate a three-dimensional image stereoscopic representation based on a viewpoint position;
an input process for outputting said viewpoint position to said three-dimensional image browser; and
a display process for receiving said three-dimensional image stereoscopic representation from said three-dimensional image browser to display it.

27. A recording medium which records a program for a client for allowing a computer to execute:
an advertisement placing process for requesting placement of an advertisement to an information providing server for storing advertisement placing information including at least a placing period of an advertisement by adding an ID for each advertisement; and
a process for allowing said information providing server to execute a contract process of the advertisement placing request, to update said stored advertisement placing information based on the contents of the contract process, to synthesize, at an information providing request from another client, three-dimensional image data generated based on image information in which a physical position is clearly described and the same area is photographed from different locations with said advertisement placing information to generate synthesis three-dimensional image data when said placing period included in said stored advertisement placing information includes the current date, and to send the synthesis three-dimensional image data to the another client.
